(19) United States
(12) Patent Application Publication
(10) Pub. No.: US 2026/0291720 A1
(43) Pub. Date: Sep. 24, 2026

(54) CLOUD BLOCKCHAIN SYSTEM AND ITS CONTROL METHOD

(71) Applicant: Bo Mi Kim, Seogwipo-si (KR)

(72) Inventor: Sang Yeob LEE, Seogwipo-si (KR)

(73) Assignee: Bo Mi Kim, Seogwipo-si (KR)

(21) Appl. No.: 19/564,935

(22) Filed: Mar. 12, 2026

(30) Foreign Application Priority Data
Mar. 18, 2025 (KR) 10-2025-0034578

(51) Int. Cl. H04L 9/08; H04L 9/00; H04L 9/32

(52) U.S. Cl. CPC H04L 9/0863; H04L 9/3297; H04L 9/50; H04L 2209/56

(57) ABSTRACT

The present disclosure discloses a cloud blockchain system and a method for controlling the same. A user terminal encrypts original data using an authentication key to generate an encrypted block, and registers request information including the encrypted block and a timestamp on a gate server. A cloud pocket accesses the gate server to verify the request information, restores the original data by decrypting the encrypted block, and stores the restored data as a new block in a blockchain or modifies existing data. By configuring the blockchain in a network-connected cloud pocket rather than on a local device, no information is stored on the personal device, and only an encrypted block protocol exists between the user and the cloud pocket. A plurality of cloud pockets are interconnected via a P2P network to enable currency functions through real-time processing.

### CROSS-REFERENCE TO RELATED APPLICATION

This application claims priority to and the benefit of Korean Patent Application No. 10-2025-0034578, filed on Mar. 18, 2025, the disclosure of which is incorporated herein by reference in its entirety.

### BACKGROUND

### 1. Field of the Invention

The present disclosure relates to a cloud blockchain system and a control method thereof. More particularly, the present disclosure relates to a cloud blockchain system and a control method thereof, configured to encrypt, at a user terminal, original data using an authentication key to generate an encrypted block, to register request information, including the encrypted block and a timestamp, on a gate server, to access, by a cloud pocket, the gate server to verify the registered request information, to restore the original data by decrypting the encrypted block contained in the request information, and to manage the blockchain by either storing the restored original data as a new block or modifying existing data with the original data.

### 2. Discussion of Related Art

Blockchain is a distributed data storage technology that encapsulates data in blocks, connects them in a chain format, and replicates and stores the data across numerous computers simultaneously. Blockchain is also referred to as a public transaction ledger.

This blockchain technology provides excellent security and offers advantages such as high data stability, the prevention of data loss, and the impossibility of unauthorized modification.

Due to these advantages, blockchain is utilized for virtual currencies and connected via Peer-to-Peer (P2P) networks. However, time delays occur during the generation and transmission of coins. Furthermore, once a coin and its associated keys are generated, the viewing keys and data should be distributed to all P2P-connected devices. This process results in a time delay ranging from as little as 30 minutes to more than 2 hours. Since these delays are physical in nature, blockchain-based coins may reduce but cannot entirely eliminate them, which presents challenges in managing such coins as a functional currency.

### Related Art Document

### Patent Document

(Patent Document 1) Korean Patent Registration No. 10-1727525 (Registration date: Apr. 11, 2017)

### SUMMARY OF THE INVENTION

An object of the present disclosure is to provide a cloud blockchain system and a method for controlling the same. The system and method are configured to: encrypt, at a user terminal, original data using an authentication key to generate an encrypted block; register request information, including the encrypted block and a timestamp, on a gate server; verify, by a cloud pocket, the request information by accessing the gate server and restore the original data by decrypting the encrypted block contained in the request information; and store the restored original data as a new block in a blockchain or modify existing data with the original data.

Another object of the present disclosure is to provide a cloud blockchain system and a method for controlling the same configured to: log in, at a user terminal, to a web server using an ID and a password and receive an authentication block provided by the web server in response to a request; register the received authentication block on a gate server; verify authentication, at a cloud pocket, by checking the consistency between the authentication block registered by the user terminal and an authentication block registered by the web server on the gate server; generate and register an authentication key with a set expiration period on the gate server upon successful authentication; and register original data in the form of a block into a cloud blockchain by interworking with the gate server and the cloud pocket, utilizing the authentication key registered on the gate server by the user terminal.

A cloud blockchain system according to an embodiment of the present disclosure includes a gate server that mediates between a user terminal and a cloud pocket. The user terminal may be configured to access one of a plurality of gate servers to be issued an authentication key from the cloud pocket, register an authentication block provided by a web server into one of a plurality of tables within the connected gate server, and receive an authentication key block corresponding to the registered authentication block. The cloud pocket may be configured to: access the gate server at a preset interval and check whether data is registered in the plurality of tables; when data is registered in at least one table, verify the data; if the data is an authentication block, interwork with the gate server to compare the authentication block registered by the web server with the authentication block registered by the user terminal for consistency; upon a match, verify the ID and password within the authentication block and generate an authentication key based on the ID, password, current time, and a preset expiration period; generate a user account encryption/decryption key consisting of a inquiry account key, a modification account key, and an computation key; and register an authentication key block, including the generated authentication key and the user account encryption/decryption key, into a table of the gate server.

In an exemplary embodiment, the user terminal may log into the web server using an identifier (ID) and a password. The web server may be configured to: generate an authentication block comprising the ID and the password based on an authentication block generation request from the user terminal; transmit the generated authentication block to the user terminal; and register the generated authentication block on a gate server interworking with the web server. The user terminal may be configured to receive the authentication block transmitted from the web server in response to the authentication block generation request.

According to an embodiment of the present disclosure, a method for controlling a cloud blockchain system includes: accessing, by a user terminal, one of a plurality of gate servers to be issued an authentication key from a cloud pocket; registering, by the user terminal, an authentication block provided by a web server into one of a plurality of tables within the connected gate server; accessing, by the cloud pocket, the gate server at a preset interval to check whether data is registered in the plurality of tables; verifying, by the cloud pocket, the registered data when it is determined that data is registered in at least one of the plurality of tables; comparing, by the cloud pocket, the authentication block registered by the web server with the authentication block registered by the user terminal for consistency by interworking with the gate server when the verified data is an authentication block; verifying, by the cloud pocket, an ID and a password included in the authentication block and generating an authentication key based on the verified ID, the password, a current time, and a preset expiration period when the authentication blocks match; generating, by the cloud pocket, a user account encryption/decryption key comprising: a inquiry account key of a preset size for interpreting encrypted data, a modification account key of a preset size for encrypting data, and an computation key of a preset size configured to prevent pattern interpretation using an arithmetic coding method; registering, by the cloud pocket, an authentication key block comprising the generated authentication key and the generated user account encryption/decryption key into the table of the gate server; and confirming, by the user terminal, the authentication key block registered in the table of the gate server.

According to an exemplary embodiment related to the present disclosure, the method may further include: generating, by the user terminal, an encrypted block by encrypting original data to be registered in the cloud blockchain using the user account encryption/decryption key included in the authentication key block, in order to store data in the cloud blockchain managed by the cloud pocket or to query data registered in the cloud blockchain; generating, by the user terminal, a request statement including the generated encrypted block and the authentication key included in the authentication key block; accessing, by the user terminal, the gate server; registering, by the user terminal, the generated request statement into one of a plurality of tables within the connected gate server; accessing, by the cloud pocket, the gate server at the preset interval to check whether data is registered in the plurality of tables; verifying, by the cloud pocket, the data registered in the table when it is determined that data is registered in at least one of the plurality of tables; performing, by the cloud pocket, a verification function on the request statement when the data registered in the table is the request statement; and performing, by the cloud pocket, any one of a block generation function, a block modification function, and a block inquiry function in the cloud blockchain based on original data decrypted from the request statement, when the verification of the request statement is successfully completed.

According to an exemplary embodiment related to the present disclosure, the performing of the verification function on the request statement includes: verifying, by the cloud pocket, whether a time difference between a current time and a timestamp included in the request statement exceeds a preset reference value to validate the data; registering, by the cloud pocket, information indicating that validity verification of the data has failed into the table of the gate server and terminating a connection with the gate server, when the request statement is determined to be invalid as a result of the validity verification; verifying, by the cloud pocket, whether a header value included in the request statement satisfies a preset specification, when the request statement is determined to be valid as a result of the validity verification; and generating original data by decrypting, by the cloud pocket, an encrypted block included in the request statement using the user account encryption/decryption key generated based on the authentication block, when the header value included in the request statement satisfies the preset specification.

According to an exemplary embodiment related to the present disclosure, the method may further include: registering, by the cloud pocket, a result of performing a function corresponding to the request statement in the table of the gate server after accessing the gate server at the preset interval; and confirming, by the user terminal, the result of performing the function registered in the table of the gate server.

According to an exemplary embodiment related to the present disclosure, the method may further include: connecting, by the cloud pocket, to a specific main server among a plurality of main servers, and storing a result of performing a function corresponding to the request statement in a specific table within a database of the specific main server; transmitting, by the specific main server, a specific vault ID corresponding to the specific table to the cloud pocket; registering, by the specific main server, the result of performing the function in respective databases of remaining main servers among the plurality of main servers, excluding the specific main server, by interworking with each of the remaining main servers; receiving, by the cloud pocket, the specific vault ID transmitted from the specific main server; registering, by the cloud pocket, the specific vault ID in the table of the gate server after accessing the gate server at the preset interval; and confirming, by the user terminal, the specific vault ID registered in the table of the gate server.

The present disclosure generates an encrypted block by encrypting original data at a user terminal using an authentication key, registers request information including the encrypted block and a timestamp on a gate server, and after verifying the request information by accessing the gate server from a cloud pocket, restores the original data by decrypting the encrypted block included in the request information. By either storing the corresponding original data as a new block in a blockchain or modifying existing data with the corresponding original data, the blockchain is configured in a cloud pocket connected to a network rather than on a personal PC or device. Consequently, no information is stored on the personal device, and only an encrypted block protocol connecting the user and the cloud pocket exists. In this state, numerous cloud pockets are interconnected via a P2P network to enable currency functions through real-time processing, providing effects such as allowing real-time modification, transmission, and generation, enabling monetary volume control, and tracking the flow of virtual currency.

Furthermore, the present disclosure provides an effect of enabling a user terminal to efficiently perform functions such as block generation and modification by using an authentication key with a preset expiration period. This is achieved through a process where: the user terminal logs into a web server using an ID and a password; the user terminal receives an authentication block provided by the web server in response to a request and registers the received authentication block on a gate server; the cloud pocket verifies authentication by checking the consistency between the authentication block registered by the user terminal and the authentication block registered by the web server on the gate server; upon successful authentication, the cloud pocket generates an authentication key with a set expiration period and registers it on the gate server; and the user terminal, utilizing the authentication key registered on the gate server, interworks with the gate server and the cloud pocket to register original data in the form of a block into a cloud blockchain.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating a configuration of a cloud blockchain system according to an embodiment of the present disclosure;

FIG. 2 is a diagram illustrating an example of a structure of a user account encryption/decryption key according to an embodiment of the present disclosure;

FIG. 3 is a diagram illustrating an example of a relationship between a Vault ID and a table in a database of a main server according to an embodiment of the present disclosure; and

FIGS. 4 to 6 are flowcharts illustrating a method for controlling a cloud blockchain system according to an embodiment of the present disclosure.

### DETAILED DESCRIPTION OF EXEMPLARY EMBODIMENTS

It should be noted that the technical terms used in the present disclosure are employed solely to describe specific embodiments and are not intended to limit the scope of the present disclosure. In addition, unless specifically defined otherwise, technical terms used herein should be interpreted with the meaning generally understood by a person of ordinary skill in the art to which the present disclosure belongs, and should not be interpreted in an excessively broad or overly restrictive sense.

Furthermore, if a technical term used in the present disclosure is an incorrect term that fails to accurately express the technical spirit of the disclosure, it should be replaced and understood with a technical term that can be correctly understood by those skilled in the art. Additionally, general terms used in the present disclosure should be interpreted according to their dictionary definitions or based on the context of the description, and should not be interpreted in an excessively restrictive sense.

Singular expressions used in the present disclosure include plural expressions unless the context clearly indicates otherwise. The terms such as "consists of" or "comprises" in the present disclosure should not be interpreted as necessarily including all of the various components or steps described in the disclosure. It should be understood that some of the components or steps may not be included, or additional components or steps may be further included.

Furthermore, terms including ordinal numbers such as "first," "second," and the like may be used to describe various components in the present disclosure, but the components should not be limited by these terms. These terms are used only for the purpose of distinguishing one component from another. For example, without departing from the scope of the present disclosure, a first component could be referred to as a second component, and similarly, a second component could also be referred to as a first component.

Hereinafter, preferred embodiments of the present disclosure will be described in detail with reference to the accompanying drawings. The same or similar components are assigned the same reference numerals regardless of the figure numbers, and redundant descriptions thereof will be omitted.

In describing the present disclosure, detailed descriptions of related well-known technologies will be omitted if it is determined that such descriptions may unnecessarily obscure the gist of the present disclosure. Furthermore, it should be noted that the accompanying drawings are provided only for the purpose of facilitating an easy understanding of the technical spirit of the present disclosure, and the spirit of the present disclosure should not be construed as being limited by the accompanying drawings.

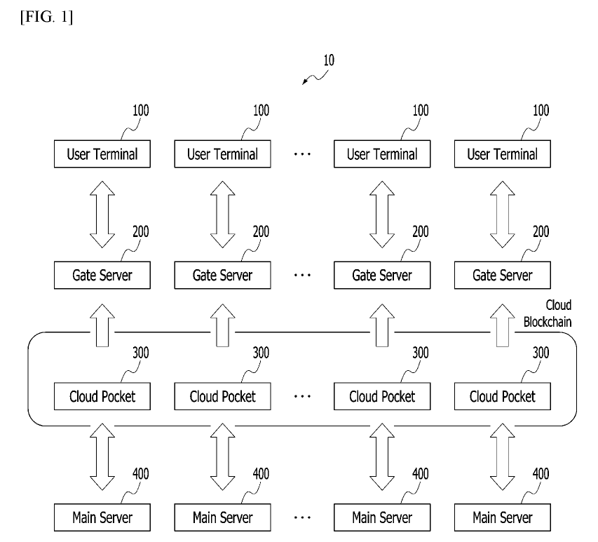

FIG. 1 is a block diagram illustrating a configuration of a cloud blockchain system 10 according to an embodiment of the present disclosure.

As shown in FIG. 1, the cloud blockchain system 10 includes a user terminal 100, a plurality of gate servers 200, a plurality of cloud pockets 300, and a plurality of main servers 400. Not all components of the cloud blockchain system 10 shown in FIG. 1 are essential components; the cloud blockchain system 10 may be implemented with more components than those shown in FIG. 1, or may be implemented with fewer components than those shown in FIG. 1.

The user terminal 100 may be implemented in or applied to various types of terminals, such as a smartphone, a portable terminal, a mobile terminal, a foldable terminal, a personal digital assistant (PDA), a portable multimedia player (PMP) terminal, a telematics terminal, a navigation terminal, a personal computer (PC), a laptop computer, a slate PC, a tablet PC, an ultrabook, a wearable device (including, for example, a smartwatch, smart glasses, a head-mounted display (HMD), etc.), a Wibro terminal, an internet protocol television (IPTV) terminal, a smart TV, a digital broadcasting terminal, an audio-video navigation (AVN) terminal, an audio/video (A/V) system, a flexible terminal, a digital signage device, an artificial intelligence (AI) speaker, and a spatial computer (including, for example, Vision Pro and the like).

The gate server 200, the cloud pocket 300, and the main server 400 may be implemented in the form of a web server, a database server, a proxy server, or the like. In addition, one or more of a network load balancing mechanism or various software for allowing the gate server 200, the cloud pocket 300, and the main server 400 to operate on the Internet or other networks may be installed therein, and thus, they may be implemented as a computerized system. Further, the network may be an HTTP network, and may include a private line, an intranet, or any other arbitrary network. Furthermore, connections among the user terminal 100, the gate server 200, the cloud pocket 300, and the main server 400 may be established via a secure network to prevent data from being attacked by an arbitrary hacker or other third parties. Additionally, the gate server 200, the cloud pocket 300, and the main server 400 may include a plurality of database servers, and may be implemented in a manner where such database servers are separately connected to the gate server 200, the cloud pocket 300, and the main server 400 through any type of network connection, including a distributed database server architecture.

Each of the user terminal 100, the gate server 200, the cloud pocket 300, and the main server 400 may include a communication unit (not shown) for performing communication functions with other terminals, a storage unit (not shown) for storing various information and programs (or applications), a display unit (not shown) for displaying various information and program execution results, an audio output unit (not shown) for outputting audio information corresponding to the various information and the program execution results, and a control unit (not shown) for controlling various components and functions of each terminal.

The user terminal 100 communicates with a web server (not shown), the plurality of gate servers 200, and the like. In this case, the user terminal 100 may be a terminal possessed by a user who performs a block generation function, a block modification function, a block inquiry function, a subscription function, and the like through a dedicated application and/or a website provided by the web server.

Furthermore, the user terminal 100, interworking with the web server, signs up as a member to be provided with the block generation function, the block modification function, the block inquiry function, the subscription function, and the like through the dedicated application and/or the website provided by the web server, and registers personal information and the like on the web server. In this case, the personal information includes an identifier (ID), an email address, a password, a name, a gender, a date of birth, contact information, an address (or address information), and the like.

Furthermore, the user terminal 100 registers a personal information usage consent form or the like, which is preset in the form of an electronic document, on the web server by interworking with the web server, in order to use functions (or services) provided by the web server.

In addition, the user terminal 100 may sign up as a user on the web server by using SNS account information or other site account information of a user of the user terminal 100. Here, the SNS account information may include information related to Facebook, Twitter, Instagram, Kakao Story, Naver Blog, and the like. Further, the other site account information may include information related to YouTube, Kakao, Naver, and the like. Additionally, mobile messenger account information may include information related to KakaoTalk, LINE, Viber, WeChat, WhatsApp, Telegram, Snapchat, and the like.

Furthermore, during a member registration procedure, the user terminal 100 may complete the member registration procedure for the web server only after an authentication function through an identity verification means (including, for example, a mobile phone, a credit card, an i-PIN, a digital certificate, and the like) is completed. Here, the digital certificate includes a joint certificate, a financial certificate, a private certificate, and the like.

In addition, after the member registration is completed, the user terminal 100 installs a dedicated app (or an application, a program, or a specific app) provided from the web server in the user terminal 100 in order to use a service provided from the web server. In this case, the dedicated app includes a native app, a mobile web app, a responsive web app (RWD), an adaptive web design (AWD) app, a hybrid app, and the like, and may be an app for performing a block generation function, a block modification function, a block inquiry function, a subscription function, and the like.

Furthermore, after membership registration is completed, the user terminal 100 may display a discount coupon provided by the web server through the dedicated app. In this case, the discount coupon may be a coupon including discount information of a certain ratio for using a file block generation function, a block modification function, a block inquiry function, a subscription function, and the like, provided by the web server.

In addition, the user terminal 100 performs a payment function according to the subscription function by interworking with the web server and a payment server (not shown) to perform the functions provided by the web server. In this case, the web server may perform the payment function through a credit card payment, an automatic transfer through interworking with a bank payment account, a payment using cash-equivalent points or cash remaining in an account of the user terminal 100 registered in the web server, or a simple payment including KakaoPay, NaverPay, and the like.

When the payment fails, the user terminal 100 receives information indicating that the payment has failed (including, for example, an insufficient balance, a limit exceeded, and the like) transmitted from the web server (or the payment server), and outputs (or displays) the received information indicating that the payment has failed.

In addition, after the payment function is normally performed, the user terminal 100 receives a result of performing the payment function transmitted from the web server, and outputs (or displays) the received payment function result. Here, the result of performing the payment function includes a subscription period, a payment amount, payment date and time information, and the like.

Furthermore, the user terminal 100 logs into (or accesses/connects to) the web server (not shown) using an identifier (ID) (or a device ID of the user terminal 100) and a password. In this case, the user terminal 100 may be in a state of having registered as a member to use a service provided by the web server.

Additionally, the user terminal 100 requests the web server to generate an authentication block according to a request of a user of the user terminal 100.

Furthermore, the web server generates an authentication block comprising an identifier (ID) (or a device ID of the user terminal 100) and a password associated with the user terminal 100, in response to an authentication block generation request (or authentication block generation request information) of the user terminal 100, and provides (or transmits) the generated authentication block to the user terminal 100.

In addition, the web server registers (or stores) the generated authentication block in a gate server 200 (or any one of a plurality of tables within the gate server 200) interworking with the web server. In this case, the gate server 200 registers (or stores) the authentication block provided from the web server into any one table among a plurality of tables (or a plurality of vaults) within the gate server 200.

Additionally, the user terminal 100 receives the authentication block provided (or transmitted) from the web server in response to the previous authentication block generation request (or authentication block generation request information). Here, after receiving the authentication block, the user terminal 100 may terminate a login state (or a connection state/link state) with the web server (or log out).

The user terminal 100 accesses (or connects to) a specific gate server 200 among the plurality of gate servers 200 to be issued an authentication key (or an authentication key block) from the cloud pocket 300. In this case, the user terminal 100 and the gate server 200 communicate using a preset HTTP protocol (or HTTPS protocol). Here, data (or information) transmitted and received between the user terminal 100 and the gate server 200 may be transmitted and received by combining internal encryption with the HTTPS protocol.

For example, the user terminal 100 generates an encrypted block (e.g., a block of 512 bytes, 1024 bytes, etc.) by encrypting data. When the generated encrypted block (or an encrypted data block) is included as byte data in the HTTP protocol (or set as bytes in an argument of HTTPS), the HTTP protocol is automatically encrypted.

Furthermore, the user terminal 100 registers (or stores) the received authentication block in the connected specific gate server 200.

That is, the user terminal 100 registers (or stores) the authentication block into a specific table (or a specific vault) among a plurality of tables (or a plurality of vaults) within the specific gate server 200.

In addition, the user terminal 100 generates an encrypted block (or encrypted data) by encrypting original data to be registered in the cloud blockchain using the user account encryption/decryption key included in the authentication key block, in order to store (or generate/modify) data in the cloud blockchain managed by the cloud pocket 300 or to query data registered in the cloud blockchain. Here, the original data (or a target block/target data) includes not only content (or information/data) (including, for example, text, numbers, binary data, and the like) but also requirements (including, for example, generation request information, modification request information, inquiry request information, and the like). Additionally, the encrypted block may include a header value (or a header value related to encryption) as well as the original data. If the size of the original data is large, it may be divided into preset units (including, for example, 512 bytes, 1024 bytes, and the like) to configure a plurality of encrypted blocks.

In this case, when the user terminal 100 generates the encrypted block, the user terminal 100 checks a timestamp within the authentication key block. If a validity period (or validity time) of the timestamp has expired based on a current time, the user terminal 100 displays information indicating that the validity period of the authentication key (or the authentication key block) has expired, interrupts (or stops) a process of generating the encrypted block, and may display (or output) information indicating a state in which the authentication block must be re-issued through communication with the web server (or re-issuance guide information for the authentication block).

Furthermore, the user terminal 100 generates a request statement (or a command statement, a request block, or a request statement block) comprising the generated encrypted block and the authentication key included in the authentication key block.

In addition, the user terminal 100 accesses (or communicates with/connects to) one specific gate server 200 among the plurality of gate servers 200. In this case, the user terminal 100 may be in a state of maintaining the previous connection with the specific gate server 200.

Additionally, the user terminal 100 registers (or stores) the generated request statement in the connected specific gate server 200.

That is, the user terminal 100 registers (or stores) the request statement into another specific table (or another specific vault) among the plurality of tables within the specific gate server 200. In this case, the user terminal 100 may cumulatively store the request statement in the specific table where data (including, for example, the authentication block and the like) was previously registered, or may initialize the specific table and then store the request statement therein.

As such, the user terminal 100 may store (or register) data to be processed (including, for example, inquiry, generation, modification, and the like) through the cloud blockchain in the specific gate server 200 interworking with the user terminal 100.

Furthermore, the user terminal 100 confirms (or displays/outputs) authentication failure information registered (or stored) in the table (or vault) of the specific gate server 200. In this case, while connected to the specific gate server 200, the user terminal 100 may receive notification information (or guide information) transmitted from the specific gate server 200 as new information (including, for example, the authentication failure information and the like) is newly registered in the table, and confirm the authentication failure information based on the received notification information. Additionally, the user terminal 100 may further display guide information indicating that a new authentication block should be re-issued through the aforementioned steps.

The user terminal 100 confirms (or displays, outputs, or downloads) the authentication key block registered (or stored) in the table (or the vault) of the specific gate server 200. In this case, while connected to the specific gate server 200, the user terminal 100 may receive notification information (or guide information) transmitted from the specific gate server 200 as new information (including, for example, the authentication key block and the like) is newly registered in the table of the specific gate server 200, and confirm the authentication key block registered in the table based on the received notification information.

Furthermore, the user terminal 100 confirms (or displays/outputs) information indicating a state where validity verification of the data registered (or stored) in the table (or the vault) of the specific gate server 200 has failed. In this case, while connected to the specific gate server 200, the user terminal 100 may receive other notification information (or other guide information) transmitted from the specific gate server 200 as new information (including, for example, information indicating that the validity verification of the data has failed) is newly registered in the table of the specific gate server 200, and confirm the information indicating that the validity verification of the data has failed based on the received other guide information. Additionally, the user terminal 100 may further display guide information indicating that a new authentication key must be re-issued through the aforementioned steps.

Furthermore, the user terminal 100 confirms (or displays/outputs) information indicating a state where specification verification of the data registered (or stored) in the table (or the vault) of the specific gate server 200 has failed. In this case, while connected to the specific gate server 200, the user terminal 100 may receive other notification information (or other guide information) transmitted from the specific gate server 200 as new information (including, for example, information indicating that the specification verification of the data has failed) is newly registered in the table of the specific gate server 200, and confirm the information indicating that the specification verification of the data has failed based on the received other guide information. Additionally, the user terminal 100 may further display guide information indicating that a new authentication key should be re-issued through the aforementioned steps.

Furthermore, the user terminal 100 confirms (or displays/outputs) a result of performing a function registered (or stored) in the table (or the vault) of the specific gate server 200. In this case, while connected to the specific gate server 200, the user terminal 100 may receive notification information (or guide information) transmitted from the specific gate server 200 as new information (including, for example, the result of performing the function) is newly registered in the table of the specific gate server 200, and confirm the result of performing the function registered in the table based on the received notification information.

The user terminal 100 confirms (or displays/outputs) a specific vault ID registered (or stored) in the table (or the vault) of the specific gate server 200.

Furthermore, the user terminal 100 uses the specific vault ID to perform a modification function, an inquiry function, or the like, regarding information (or data) related to a corresponding case in the future.

The gate server 200 communicates with the web server, the user terminal 100, the cloud pocket 300, and the like. Here, the gate server 200 may temporarily store data (or information) provided from the user terminal 100, provide the temporarily stored data in response to a request from the cloud pocket 300, temporarily store a result of performing a function provided from the cloud pocket 300 in response to the data, and provide the temporarily stored result of performing the function to the user terminal 100. The gate server 200 may be a server that performs a role of a mediator (or a relay function).

In addition, the gate server 200 is provided in plurality, and the plurality of gate servers 200 share and store data respectively stored in each gate server 200 with each other. In this case, the plurality of gate servers 200 may share (or synchronize data) regarding data stored (or registered) in each of the gate servers 200 with each other.

In addition, a plurality of cloud pockets 300 may access one gate server 200. Here, the plurality of gate servers 200 have different addresses (including, for example, IP addresses, URL addresses, and the like).

For example, a first cloud pocket 300 to a 100th cloud pocket 300 may access a first gate server 200, and a 101st cloud pocket 300 to a 200th cloud pocket 300 may access a second gate server 200.

Additionally, a single cloud pocket 300 may also access a plurality of gate servers 200.

As such, connections between the plurality of gate servers 200 and the plurality of cloud pockets 300 may be managed by a preset policy (including, for example, a policy where the 1st cloud pocket to the 100th cloud pocket access the first gate server 200, and the like).

Furthermore, the gate server 200 interworks with the web server to register (or store) the authentication block provided by the web server into the gate server 200 (or any table among a plurality of tables within the gate server 200).

In addition, the gate server 200 is configured to interwork with each of remaining gate servers 200, excluding the gate server 200 itself, among the total plurality of gate servers 200, to respectively store (or register/update) the authentication block in the remaining gate servers 200.

Furthermore, the gate server 200 connects to the user terminal 100 for issuing an authentication key (or an authentication key block) from the cloud pocket 300. In this case, the user terminal 100 and the gate server 200 communicate using a preset HTTP protocol (or HTTPS protocol).

Moreover, the gate server 200 interworks with the user terminal 100 to register (or store) the authentication block in any one specific table (or a specific vault) among a plurality of tables (or vaults) within the specific gate server 200. In this case, the specific gate server 200 may allocate at least one table related to the user terminal 100 among the plurality of tables managed by the specific gate server 200, and register the authentication block in any one of the at least one allocated table.

In addition, the gate server 200 connects to at least one cloud pocket 300 among the plurality of cloud pockets 300. In this case, a connection between the gate server 200 and the cloud pocket 300 may be a unidirectional communication in which only the cloud pocket 300 accesses the specific gate server 200.

Furthermore, when data registered by the user terminal 100 exists in at least one table among the plurality of tables within the gate server 200, the gate server 200 transmits (or provides) the data to the cloud pocket 300 in response to a request from the cloud pocket 300.

Furthermore, the gate server 200 interworks with the cloud pocket 300 to register (or store) the authentication key block generated by the cloud pocket 300 into the table (or the vault) of the specific gate server 200. Here, the gate server 200 stores the authentication key block in addition to data previously stored (including, for example, the authentication block and the like) in the table, or deletes the data stored in the table and then stores the authentication key block. In this case, the gate server 200 may respectively store the authentication key block, the authentication block, and the like in different tables among the plurality of tables of the specific gate server 200.

In addition, the gate server 200 interworks with the user terminal 100 to register (or store) the request statement generated by the user terminal 100 into another specific table (or another specific vault) among the plurality of tables within the gate server 200.

Additionally, the gate server 200 interworks with the cloud pocket 300 to register (or store) a result of performing a function (including, for example, a result of performing a block generation function, a block modification function, a block inquiry function, and the like) generated by the cloud pocket 300 into the table of the specific gate server 200. Here, the gate server 200 stores the result of performing the function in addition to data previously stored (including, for example, the authentication block, the request statement, and the like) in the table, or deletes the data stored in the table and then stores the result of performing the function. In this case, the gate server 200 may separately store the authentication key block, the authentication block, the request statement, the result of performing the function, and the like in different tables among the plurality of tables of the specific gate server 200. Here, even when the data such as the authentication key block, the authentication block, the request statement, and the result of performing the function are stored separately, the gate server 200 may confirm which user terminal 100 the respective data is associated with by using a header (or a header value) included in each piece of data.

The cloud pocket (CP) 300 (also referred to as a cloud server, a cloud pocket server, or a blockchain cloud pocket) communicates with the plurality of gate servers 200, the plurality of main servers 400, and the like. Here, at least one gate server 200 among the plurality of gate servers 200 is allocated to the cloud pocket 300 according to a preset policy (or condition), and the cloud pocket 300 may connect to the allocated at least one gate server 200. In this case, the cloud pocket 300 accesses the gate server 200 through unidirectional communication and accesses the gate server 200 at a preset interval. Furthermore, the plurality of cloud pockets 300 may share (or synchronize) data stored (or registered) in each of the cloud pockets 300 with each other.

Additionally, the cloud pocket 300 provides a cloud service utilizing blockchain technology, which covers from infrastructure (or hardware) configuring a blockchain network to application development and operation.

A server in an Internet Data Center (IDC) may serve as the cloud pocket 300.

For example, in the case of a Linux server, a plurality of independently running threads may be launched. In this case, one thread becomes the cloud pocket 300.

As another method, if a hub is connected to an IDC and a plurality of devices are attached to the hub, each individual device may serve as the cloud pocket 300.

In this manner, both an independent process CP on a server side and a device CP are possible.

All of these CPs are connected via a blockchain.

For example, if a hundred processes exist in one server and thirty smartphones are connected with five smartphones per hub, there are a total of two hundreds and fifty cloud pockets 300, including the hundred processes and one hundred and fifty smartphones.

In addition, all of these cloud pockets 300 identically possess the same data.

Furthermore, the cloud pocket 300 manages (or configures/operates) a cloud blockchain. Here, the cloud blockchain is a system combining cloud computing and blockchain technology, and may be a method of providing data storage, processing, security, and management related to a blockchain network in a cloud environment.

As described above, the cloud blockchain system 10 according to the present invention is a technology in which a blockchain is configured in a cloud pocket connected to a network, rather than being configured in a personal PC or device.

Accordingly, because coins are connected via the blockchain to the cloud pocket 300 on the network connected to a coin holder (or a user of the user terminal 100), no information is stored in the personal device. However, only an encrypted block protocol for establishing a connection between the user and the cloud pocket 300 exists in the user terminal 100.

In addition, numerous cloud pockets 300 are connected to each other via P2P on a network, and because multiple wallets are stored in one cloud pocket 300, a P2P speed is very high, and thus real-time transmission may be processed.

Furthermore, the cloud pocket 300 manages (or stores) a pocket server list, which is information related to other cloud pockets 300. Here, the pocket server list includes information on which cloud pocket 300 a wallet (or a cryptocurrency/virtual currency wallet) corresponding to a user account is stored (or managed) in, and includes cloud pocket information (or an address/URL of the cloud pocket 300) for each piece of wallet information.

In addition, when the cloud pocket 300 is an independent terminal, the cloud pocket 300 may have one address.

Additionally, one process of one large-scale server may serve as the cloud pocket 300. In this case, the pocket server list may be located in the large-scale server.

That is, the cloud pocket 300 may be a terminal (including, for example, a PC and the like) or may be a shell process of a server.

Therefore, when the cloud pocket 300 establishes a connection, it accesses via an IP address if the IP address is available, and in the case of being a process of a specific server, it connects using the pocket server list of the specific server.

In addition, the cloud pocket 300 connects to (or communicates with) the specific gate server 200 at a preset interval, and then checks whether data (including, for example, an authentication block) is in a registered (or stored) state in a plurality of tables (or vaults) within the specific gate server 200. In this case, at least one gate server 200 to be managed by the cloud pocket 300 is in an allocated (or set) state among a plurality of gate servers 200, and the cloud pocket 300 may respectively access the at least one gate server 200 according to the interval to check whether data is registered in the tables. Here, the cloud pocket 300 is one of a plurality of cloud pockets 300 and is preset to communicate with the specific gate server 200, and the connection between the cloud pocket 300 and the specific gate server 200 may be unidirectional communication in which only the cloud pocket 300 accesses the specific gate server 200.

As a result of the check, if data is in a registered state in at least one table among the plurality of tables, the cloud pocket 300 confirms the data registered in the table.

That is, the cloud pocket 300 regularly accesses the specific gate server 200 at constant time intervals (or cycles) while running a loop (or a thread), and checks whether there is a task (or data) to be processed by the cloud pocket 300. Here, the task to be processed by the cloud pocket 300 may be a function related to data registered in the table within the specific gate server 200 by an arbitrary user terminal 100 or the like.

Furthermore, as a result of the check, if data is not registered in any of the plurality of tables, the cloud pocket 300 interworks with the specific gate server 200 again in a next cycle (or a next thread) to perform a process of checking whether data is registered in the tables.

In addition, when the data is an authentication block, the cloud pocket 300 interworks with the specific gate server 200 to compare (or verify) whether the authentication block registered by the web server in the specific gate server 200 matches the authentication block registered by the user terminal 100 in the specific gate server 200. Here, the cloud pocket 300 may perform parsing (or syntax analysis) on the data, confirm a type (or content) of the data based on a result of the parsing, and confirm whether the data is an authentication block including an ID and a password based on the confirmed type of the data. In this case, the cloud pocket 300 may also confirm whether the data is an authentication block based on a header of the data (or additional information included in the data).

As a result of the comparison (or the check), when the authentication block registered (or stored) in the specific gate server 200 by the web server does not match the authentication block registered (or stored) in the specific gate server 200 by the user terminal 100, the cloud pocket 300 registers (or stores) authentication failure information in the table (or the vault) of the specific gate server 200, and terminates the connection with the specific gate server 200. In this case, the cloud pocket 300 stores the authentication failure information in addition to data previously stored (including, for example, the authentication block and the like) in the table, or deletes the data stored in the table and then stores the authentication failure information. Here, the cloud pocket 300 may respectively store the authentication failure information and the authentication block in different tables among the plurality of tables of the specific gate server 200.

Furthermore, as a result of the comparison (or the check), when the authentication block registered by the web server matches the authentication block registered by the user terminal 100, the cloud pocket 300 confirms the identifier (ID) (or device ID), the password, and the like included in the authentication block.

In addition, the cloud pocket 300 generates (or issues) an authentication key based on the confirmed ID, password, current time, and a preset validity period. In this case, the authentication key includes the ID (or device ID), the password, and a timestamp including validity period information for the authentication key. Here, the validity period may be a preset value (including, for example, 3 minutes, 5 minutes, 10 minutes, and the like).

Additionally, the cloud pocket 300 generates a user account encryption/decryption key. Here, the user account encryption/decryption key may be used in a preset state or may be generated and used upon request, and comprises (or includes) an inquiry account key (or a decryption key), a modification account key (or an encryption key), and a computation key. The user account encryption/decryption key is not an account key used for access (login), but a key used for decrypting an encrypted block or encrypting general data. Furthermore, the cloud pocket 300 uses a computational encryption method as an encryption method for the cloud blockchain. Accordingly, the computation key is additionally added along with the two keys (inquiry and modification keys). The encryption method using computation (or a computational encoding scheme) is a method already widely used in computers and thus will not be described in detail herein.

That is, the cloud pocket 300 generates the user account encryption/decryption key, which is a byte key of a preset size (e.g., 256 bytes times three), and the byte key indicates that the key unit is in bytes.

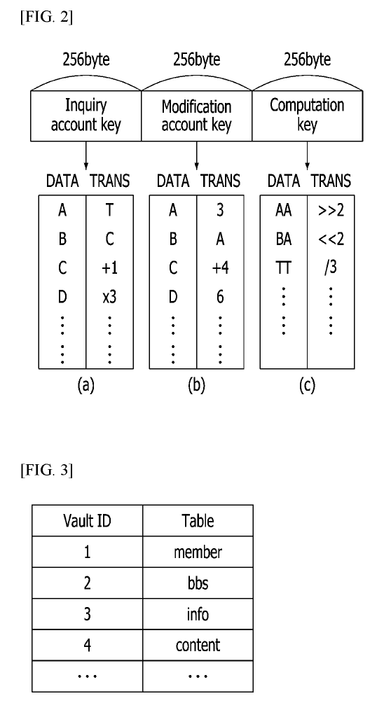

As shown in FIG. 2, the cloud pocket 300 generates the user account encryption/decryption key consisting of an inquiry account key of a preset size (e.g., 256 bytes) for interpreting (or decrypting) encrypted data, a modification account key of a preset size (e.g., 256 bytes) for encrypting data, and a computation key of a preset size (e.g., 256 bytes) for making interpretation via patterns impossible by using the computational encoding scheme.

In an embodiment of the present invention, it is mainly described that the cloud pocket 300 generates the user account encryption/decryption key when a user account is created (or when the authentication key is generated, or when the user terminal 100 registers the authentication block in the gate server 200). However, the present invention is not limited thereto, and the cloud pocket 300 may use a pre-stored user account encryption/decryption key, which is commonly used by the plurality of cloud pockets 300, to generate the authentication key block.

Furthermore, the cloud pocket 300 registers (or stores) an authentication key block including the generated authentication key and the generated user account encryption/decryption key into the table (or the vault) of the specific gate server 200. In this case, the cloud pocket 300 may store the authentication key block in addition to data previously stored (including, for example, the authentication block and the like) in the table, or may delete the data stored in the table and then store the authentication key block. In this case, the cloud pocket 300 may respectively store the authentication key block, the authentication block, and the like in different tables among a plurality of tables of the specific gate server 200.

In addition, the cloud pocket 300 interworks with one main server 400 among the plurality of main servers 400 to store (or register) the authentication key block in one record within one table among a plurality of tables in a database (not shown) of the main server 400. In this case, as the authentication key block is stored in a specific record within a specific table of the database, the cloud pocket 300 receives a vault ID (or a vault ID corresponding to the specific table) provided from the main server 400. Here, the cloud pocket 300 may also store the vault ID when storing the authentication key block in the table within the specific gate server 200.

As described above, the cloud pocket 300 and the main server 400 are connected, such that the cloud pocket 300 may possess its own data block and may perform overall flow control and management by sending the data to the main server 400.

In addition, after connecting to (or communicating with) the specific gate server 200 at the preset interval, the cloud pocket 300 checks whether data (including, for example, a request statement) is in a registered (or stored) state in a plurality of tables (or vaults) within the specific gate server 200.

As a result of the check, if data is in a registered state in at least one table among the plurality of tables, the cloud pocket 300 confirms the data registered in the table (or vault).

That is, the cloud pocket 300 regularly accesses the specific gate server 200 at constant time intervals (or periods) while running a loop (or a thread), and checks whether there is a task (or data) to be processed by the cloud pocket 300. Here, the task to be processed by the cloud pocket 300 may be a function related to data registered in the table within the specific gate server 200 by an arbitrary user terminal 100 or the like.

Furthermore, as a result of the check, if data is not registered in any of the plurality of tables, the cloud pocket 300 interworks with the specific gate server 200 again in a next cycle (or a next thread) to perform a process of checking whether data is registered in the tables.

In addition, when the data is a request statement, the cloud pocket 300 primarily performs validity verification (or determination) on the data (or the request statement) based on a timestamp included in the request statement. Here, the cloud pocket 300 may perform parsing (or syntax analysis) on the data, confirm a type (or content) of the data based on a result of the parsing, and confirm whether the data is a request statement including an encrypted block, an authentication key, and the like based on the confirmed type of the data. In this case, the cloud pocket 300 may also confirm whether the data is a request statement based on a header of the data (or additional information included in the data).

That is, when the data is a request statement, the cloud pocket 300 verifies (or determines) whether a time difference between a current time and a timestamp included in the request statement has passed (or exceeded) a preset reference value (including, for example, 3 seconds, 5 seconds, 10 seconds, and the like) based on the current time and the timestamp included in the request statement, in order to verify validity of the data (or the request statement).

As a result of the validity verification of the data, when the request statement is determined to be invalid, the cloud pocket 300 registers (or stores) information indicating that the validity verification of the data has failed in the table (or the vault) of the specific gate server 200, and terminates the connection with the specific gate server 200. Here, the cloud pocket 300 stores information indicating that the validity verification of the data has failed in addition to data previously stored (including, for example, the authentication block, the request statement, and the like) in the table of the specific gate server 200, or deletes the data stored in the table and then stores the information indicating that the validity verification of the data has failed. Here, the cloud pocket 300 may respectively store the information indicating that the validity verification of the data has failed, the authentication block, the request statement, and the like in different tables among a plurality of tables of the specific gate server 200.

That is, if the time difference between the current time and the timestamp included in the request statement has passed (or exceeded) the preset reference value (including, for example, 3 seconds, 5 seconds, 10 seconds, and the like), the cloud pocket 300 registers (or stores) information indicating that the validity verification of the data has failed in the table (or the vault) of the specific gate server 200, and terminates the connection with the specific gate server 200.

In addition, as a result of the validity verification of the data (or a result of determining the validity of the data/request statement), if the request statement is determined to be valid, the cloud pocket 300 secondarily checks (or determines) whether a header value included in the request statement matches (or satisfies) a preset specification (or condition). Here, the header value may be a value generated in a process of encrypting the encrypted block included in the request statement.

Specifically, if the time difference between the current time and the timestamp included in the request statement has not passed (or has not exceeded) the preset reference value (including, for example, 3 seconds, 5 seconds, 10 seconds, and the like), the cloud pocket 300 determines that the request statement is valid, and secondarily checks (or determines) whether the header value included in the request statement matches (or satisfies) the preset specification (or condition).

As a result of the check (or the determination), if the header value included in the request statement does not match (or satisfy) the preset specification (or condition), the cloud pocket 300 registers (or stores) information indicating that the specification verification of the data has failed in the table (or the vault) of the specific gate server 200, and terminates the connection with the specific gate server 200. Here, the cloud pocket 300 stores the information indicating that the specification verification of the data has failed in addition to data previously stored (including, for example, an authentication block, a request statement, and the like) in the table, or deletes the data stored in the table and then stores the information indicating that the specification verification of the data has failed. In this case, the cloud pocket 300 may respectively store the information indicating that the specification verification of the data has failed, the authentication block, the request statement, and the like in different tables among a plurality of tables of the specific gate server 200.

Furthermore, as a result of the check (or the determination), if the header value included in the request statement matches (or satisfies) the preset specification (or condition), the cloud pocket 300 tertiarily decrypts the encrypted block included in the request statement using a preset user account encryption/decryption key (or the user account encryption/decryption key generated based on the authentication block associated with the user terminal 100 previously) to generate (or restore) original data.

That is, as a result of the secondary specification verification of the data, when the header value included in the request statement matches (or satisfies) the preset specification (or condition), the cloud pocket 300 separates the request statement into an authentication key and an encrypted block, and decrypts the separated encrypted block using the user account encryption/decryption key to generate (or restore) original data.

In addition, the cloud pocket 300 performs a block generation function, a block modification function, a block inquiry function (or a block content inquiry function), and the like, in the cloud blockchain based on the original data and the like.

That is, the cloud pocket 300 performs parsing (or syntax analysis) on the original data and identifies a meaning (or content) of the original data according to the parsing (or a result of the parsing).

Furthermore, when a requirement included in the request statement is a new block generation request (or when the identified meaning/content is a new block generation request), the cloud pocket 300 checks whether the block is to be generated in the cloud pocket 300 among a pocket server list managed by the cloud pocket 300.

That is, the cloud pocket 300 checks, through the pocket server list, whether the new block generation request is a task (or function) to be performed in the cloud pocket 300, which is a local server. Here, the pocket server list includes information on which cloud pocket 300 a wallet (or a cryptocurrency/virtual currency wallet) corresponding to a user account is stored (or managed) in, and includes cloud pocket information (or an address/URL of the cloud pocket 300) for each piece of wallet information.

As a result of the checking, if the block generation is to be performed in the cloud pocket 300, the cloud pocket 300 performs the block generation function in the cloud blockchain based on the original data.

That is, as a result of the checking, when it is confirmed that the new block generation request is a task (or function) to be performed in the cloud pocket 300, which is the local server that has checked the request statement, the cloud pocket 300 performs the block generation function based on the original data in the cloud pocket 300. In this case, the cloud pocket 300 may also perform a block generation function of creating a new wallet for a user associated with the request statement and managing information related to the newly created wallet.

In addition, the cloud pocket 300 updates a result of performing the block generation function related to the new block generation (or updates according to the new block generation in the cloud blockchain).

In addition, the cloud pocket 300 updates results of performing the block generation function related to the new block generation in each of remaining cloud pockets 300, excluding the cloud pocket 300 itself among all the cloud pockets 300, by using threads.

Furthermore, as a result of the checking, in the case of block generation in another cloud pocket 300 (or in the case where the block generation is not in the local server that checked the request statement), the cloud pocket 300 identifies another cloud pocket 300 in charge of performing the block generation function based on the pocket server list managed by the cloud pocket 300, and provides the request statement (or the original data) to the identified another cloud pocket 300.

Accordingly, the other cloud pocket 300 performs the block generation function in the cloud blockchain based on the request statement (or the original data). At this time, the other cloud pocket 300 may perform a block generation function of newly creating a user wallet associated with the request statement and managing information related to the newly created wallet.

In addition, after completing the performance of the block generation function, the cloud pocket 300 updates a result of performing the block generation function related to the new block generation (or a result of performing the block generation function related to the new block generation in the other cloud pocket 300) (or an update according to the new block generation in the cloud blockchain). In this case, the cloud pocket 300 may update result information on the user wallet newly created according to the request statement.

Furthermore, the cloud pocket 300 updates the results of performing the block generation function related to the new block generation in each of the remaining cloud pockets 300, excluding the cloud pocket 300 itself among all the cloud pockets 300, by using threads.

At this time, the other cloud pocket 300 updates the result of performing the block generation function related to the new block generation in the other cloud pocket 300, and may update the result of performing the block generation function related to the new block generation in each of the remaining cloud pockets 300, excluding the other cloud pocket 300 itself among all the cloud pockets 300, by using threads.

Additionally, when a requirement included in the request statement is a block modification request (or when the identified meaning is a block modification request), the cloud pocket 300 checks whether a primary modification cloud pocket 300 is local based on the pocket server list managed by the cloud pocket 300.

That is, regarding the block modification request, the cloud pocket 300 checks, through the pocket server list, whether the primary modification cloud pocket 300 is a task (or function) to be performed in the cloud pocket 300, which is the local server.

As a result of the checking, when the primary modification is to be performed in the cloud pocket 300, the cloud pocket 300 performs a primary block modification function in the cloud blockchain based on the original data. Here, the primary block modification function indicates a block modification function targeting a target party.

Specifically, when it is confirmed that the primary modification cloud pocket 300 is a task (or function) to be performed in the local server that has checked the request statement, the cloud pocket 300 performs the primary block modification function based on the original data. Here, the cloud pocket 300 may perform a block modification function of deducting an amount of cryptocurrency included in the request statement from a user's wallet associated with the request statement.

Furthermore, as a result of the checking, in the case where the primary modification is to be performed in another cloud pocket 300 (or in the case where the primary block modification is not in the local server that checked the request statement), the cloud pocket 300 identifies another cloud pocket 300 in charge of performing the primary block modification function based on the pocket server list, and provides the request statement (or the original data) to the identified another cloud pocket 300.

Accordingly, the other cloud pocket 300 performs the primary block modification function in the cloud blockchain based on the request statement (or the original data). Here, the other cloud pocket 300 may perform a block modification function of deducting the amount of cryptocurrency included in the request statement from the user's wallet associated with the request statement.

In addition, the cloud pocket 300 interworks with the other cloud pocket 300 to ascertain (or confirm) whether the performance of the primary block modification function in the other cloud pocket 300 is completed.

Furthermore, after the primary block modification function is completed, the cloud pocket 300 checks whether a secondary modification cloud pocket 300 is local based on the pocket server list.

That is, regarding the block modification request, the cloud pocket 300 determines, through the pocket server list, whether the secondary modification cloud pocket 300 is a task (or function) to be performed in the cloud pocket 300, which is the local server.

As a result of the determination, when the secondary modification is to be performed in the cloud pocket 300, the cloud pocket 300 performs a secondary block modification function in the cloud blockchain based on the original data. Here, the secondary block modification function indicates a block modification function targeting a counterparty (or a recipient party).

Specifically, when it is determined that the secondary modification cloud pocket 300 is a task (or function) to be performed in the cloud pocket 300, which is the local server that has checked the request statement, the cloud pocket 300 performs the secondary block modification function in the cloud blockchain based on the original data. In this case, the cloud pocket 300 may perform a block modification function of processing (e.g., deducting or updating) an amount of cryptocurrency included in the request statement in a wallet associated with the request statement.

Furthermore, as a result of the determination, in the case where the secondary modification is to be performed in another cloud pocket 300 (or in the case where the secondary block modification is not in the local server that checked the request statement), the cloud pocket 300 identifies another cloud pocket 300 in charge of performing the secondary block modification function based on the pocket server list, and provides the request statement (or the original data) to the identified another cloud pocket 300.

Accordingly, the other cloud pocket 300 performs the secondary block modification function in the cloud blockchain based on the request statement (or the original data). Here, the other cloud pocket 300 may perform a block modification function of processing the amount of cryptocurrency included in the request statement in the user's wallet associated with the request statement.

In addition, the cloud pocket 300 interworks with the other cloud pocket 300 to ascertain (or confirm) whether the performance of the secondary block modification function in the other cloud pocket 300 is completed.

Furthermore, after completing the performance of the primary and secondary block modification functions, the cloud pocket 300 updates a result of performing the block modification function related to the block modification (e.g., results from the local cloud pocket 300, the other cloud pocket 300, etc.) (or updates according to the block modification in the cloud blockchain). Here, the cloud pocket 300 may update result information regarding changes in the wallets of the target party and the counterparty according to the transfer of cryptocurrency based on the request statement.

Additionally, the cloud pocket 300 updates the results of performing the block modification function related to the block modification in each of remaining cloud pockets 300, excluding the cloud pocket 300 itself among all the cloud pockets 300, by using threads.

As described above, when the requirement included in the request statement is a block modification request (or when the identified meaning is a block modification request / in a case of wishing to transmit coins), a blockchain connection order is determined such that a cloud pocket 300 where a sender's block is stored and a cloud pocket 300 where a recipient's block is stored are preferentially modified. Once the modification function in the cloud pocket 300 of the sender and the cloud pocket 300 of the recipient is completed, the system is configured to update the result of performing the block modification function in each of all the remaining cloud pockets 300 among the plurality of cloud pockets 300. This applies a method distinguished from a conventional blockchain connection based on unspecified random P2P methods.

Furthermore, when the requirement included in the request statement is a block inquiry request (or when the identified meaning is a block inquiry request), the cloud pocket 300 checks whether the block inquiry is to be performed in the cloud pocket 300 among a pocket server list managed by the cloud pocket 300.

That is, the cloud pocket 300 checks, through the pocket server list, whether the block inquiry request is a task (or function) to be performed in the cloud pocket 300, which is a local server.

As a result of the checking, if the block inquiry is to be performed in the cloud pocket 300, the cloud pocket 300 performs a function of checking information (or information/data within a block) corresponding to the block inquiry request in the cloud blockchain.

Specifically, when it is confirmed that the block inquiry request is a task (or function) to be performed in the local server that has checked the request statement, the cloud pocket 300 performs the block inquiry function based on the original data in the cloud blockchain. In this case, the cloud pocket 300 may perform an inquiry function of checking a balance remaining in a user's wallet associated with the request statement.

In addition, the cloud pocket 300 updates a result of performing the block inquiry function (or an update according to the block inquiry in the cloud blockchain).

The cloud pocket 300 updates the results of performing the block inquiry function in each of the remaining cloud pockets 300, excluding the cloud pocket 300 itself among all the cloud pockets 300, by using threads.

Moreover, as a result of the checking, in the case of a block inquiry in another cloud pocket 300 (or in the case where the block inquiry is not in the local server that checked the request statement), the cloud pocket 300 identifies another cloud pocket 300 in charge of performing the block inquiry function based on the pocket server list, and provides the request statement (or the original data) to the identified another cloud pocket 300.

Accordingly, another cloud pocket 300 performs a block inquiry function in the cloud blockchain based on the request statement (or the original data). In this case, the other cloud pocket 300 may perform an inquiry function of checking a balance remaining in a user's wallet associated with the request statement.

Furthermore, after completing the performance of the block inquiry function, the cloud pocket 300 updates a result of performing the block inquiry function (or a result of performing the block inquiry function related to the block inquiry in the other cloud pocket 300) (or updates according to the block inquiry in the cloud blockchain). Here, the cloud pocket 300 may update information regarding the balance remaining in the user's wallet according to the request statement.

In addition, the cloud pocket 300 updates the results of performing the block inquiry function in each of remaining cloud pockets 300, excluding the cloud pocket 300 itself among all the cloud pockets 300, by using threads.

In this case, the other cloud pocket 300 updates the result of performing the block inquiry function in the other cloud pocket 300, and may also update the results of performing the block inquiry function in each of the remaining cloud pockets 300, excluding the other cloud pocket 300 itself among all the cloud pockets 300, by using threads.

As described above, the cloud pocket 300 implements a blockchain (or a cloud blockchain) through a plurality of cloud pockets 300, thereby reducing risks such as hacking.

Moreover, after connecting to (or communicating with/accessing) the specific gate server 200 at a preset interval, the cloud pocket 300 registers (or stores) a result of performing a function (including, for example, a result of performing a block generation function, a block modification function, a block inquiry function, and the like) corresponding to the request statement into the table (or the vault) of the specific gate server 200. Here, the cloud pocket 300 stores the result of performing the function in the table where data (including, for example, an authentication block, an authentication key block, a request statement, and the like) was previously registered in relation to the user terminal 100, or deletes the data stored in the table and then stores the result of performing the function. In this case, the cloud pocket 300 may respectively store the authentication block, the authentication key block, the request statement, the result of performing the function, and the like in different tables among a plurality of tables of the specific gate server 200.

As described above, while conventional blockchain-based virtual currencies are somewhat unsuitable for functioning as a currency, the cloud pocket 300 (or the cloud blockchain system 10) is configured to enable monetary functions while maintaining the advantages of a blockchain.

Furthermore, the cloud blockchain system 10 allows for real-time modification, transmission, and generation, enables control over the money supply, and can track the flow of currency.

The cloud pocket 300 connects to (or accesses/communicates with) one of the plurality of main servers 400, and stores (or registers) a result of performing a function (including, for example, a result of performing a block generation function, a block modification function, a block inquiry function, and the like) into a specific table within a database (not shown) in the connected main server 400.

Additionally, the cloud pocket 300 receives a specific vault ID related to the specific table in which the result of performing the function is stored, provided from the main server 400.

After connecting to (or communicating with/accessing) the specific gate server 200 at a preset interval, the cloud pocket 300 registers (or stores) the specific vault ID into the table (or the vault) of the specific gate server 200. Here, the cloud pocket 300 may cumulatively store the specific vault ID in the table within the specific gate server 200 where data (including, for example, an authentication block, an authentication key block, a request statement, and the like) was previously registered in relation to the user terminal 100, or may initialize the table and then store the specific vault ID therein. In this case, the cloud pocket 300 may respectively store the authentication block, the authentication key block, the request statement, the specific vault ID, and the like in different tables among the plurality of tables of the specific gate server 200.

The main server 400 communicates with the plurality of cloud pockets 300. Here, the main server 400 is provided in plurality, and the plurality of main servers 400 share data stored in each of the main servers 400. In this case, the plurality of main servers 400 may share (or synchronize) data stored (or registered) in each of the main servers 400 with each other.

Furthermore, the main server 400 is configured as (or includes) a database server (not shown).

The main server 400 connects to (or accesses/communicates with) at least one cloud pocket 300 among the plurality of cloud pockets 300. Here, a connection between the cloud pocket 300 and the main server 400 is configured as bidirectional communication, and they communicate using a preset TCP/IP protocol. In this case, the TCP/IP protocol is custom-developed, and protocol information thereof is private (or non-disclosed).

The main server 400 is configured to strictly avoid using general public server protocols (including, for example, HTTP, TELNET, FTP, and the like), thereby preventing any access through publicly authorized protocols from external sources.

Furthermore, the main server 400 is connected to the cloud pocket 300 through bidirectional communication. In a server-client architecture, the main server 400 is configured as a server, and the cloud pocket 300 is configured as a client.

Additionally, when connecting via TCP/IP, the main server 400 keeps connection port numbers private.

That is, the main server 400 does not permit any access other than from the cloud pocket 300.

Security functions of the main server 400 are implemented through an IP address and a port number of the main server 400, device authentication of the cloud pocket 300, a custom protocol, and the like.

Since the main server 400 is inaccessible from the outside, it transmits and receives data (or information) with the cloud pocket 300 in an unencrypted state.

As shown in FIG. 3, the main server 400 manages a database comprising vault IDs and tables corresponding to the vault IDs.

That is, the main server 400 performs a function of reading or modifying a specific record of a specific table in a specific database.

For example, as shown in FIG. 3, the main server 400 matches a member table with a first vault ID (or a vault ID corresponding to a first vault). An external device (e.g., the cloud pocket 300) is configured to access a record of the member table in the main server 400 by using the first vault ID instead of using the actual "member" table name. Within the main server 400, the table (or table name) corresponding to the vault ID is used for internal processing.

Furthermore, the main server 400 interworks with the cloud pocket 300 to store (or register) a result of performing a function (including, for example, a result of performing a block generation function, a block modification function, a block inquiry function, and the like) regarding a specific request statement from the cloud pocket 300 into a specific table in the database within the main server 400.

In addition, the main server 400 provides a specific vault ID corresponding to the specific table where the result of performing the function is stored to the cloud pocket 300. In this case, instead of directly providing information related to the table where the function result is stored to the cloud pocket 300, the main server 400 provides a preset vault ID corresponding to the table. This is configured to prevent the cloud pocket 300 from identifying direct information regarding data (or the result of performing the function) stored in the database of the main server 400.

Furthermore, the main server 400 interworks with each of the remaining main servers 400, excluding the corresponding one main server 400 among the plurality of main servers 400, to respectively store (or share, register, or update) a result of performing a function (including, for example, a result of performing a block generation function, a block modification function, a block inquiry function, and the like) in databases respectively configured in the remaining main servers 400.
1. The main server 400 keeps only one port open, and the port number is private and cannot be known from the outside.
2. The main server 400 uses a proprietary protocol that is unknown to the outside.
3. No TCP/IP communication other than the connection with the cloud pocket 300 is connected to the main server 400. Since even protocols such as SSH or TFTP are not connected, external hacking cannot gain access using publicly authorized protocols.
4. Communication between the main servers 400 is performed using a single port. However, this communication allows only main server URLs and fundamentally blocks other external accesses.

As described above, the user terminal 100 encrypts original data using an authentication key to generate an encrypted block, and registers request information including the encrypted block and a timestamp into the gate server 200. Then, the cloud pocket 300 accesses the gate server 200 to confirm the request information, decrypts the encrypted block included in the request information to restore the original data, and may store the original data as a new block in the blockchain or modify existing data into the original data.

In addition, as described above, after a user logs in to the web server using an ID and a password through the user terminal 100, the user terminal 100 receives an authentication block provided by the web server upon request and registers the received authentication block into the gate server 200. Then, the cloud pocket 300 verifies authentication by checking whether the authentication block registered in the gate server 200 by the user terminal 100 matches the authentication block registered in the gate server 200 by the web server. If authentication is successful, the cloud pocket 300 generates an authentication key for which a validity period is set and registers it in the gate server 200. The user terminal 100 can then register the original data in the form of a block into the cloud blockchain by interworking with the gate server 200 and the cloud pocket 300 using the authentication key registered in the gate server 200.

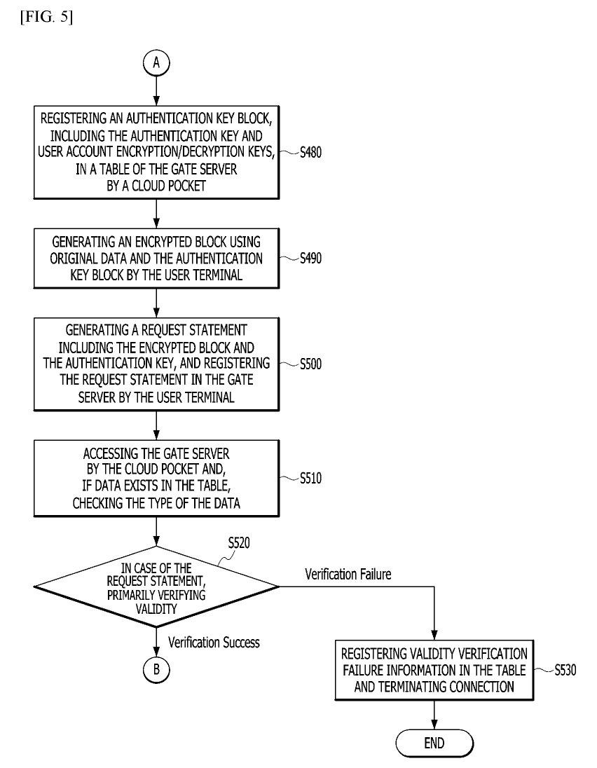

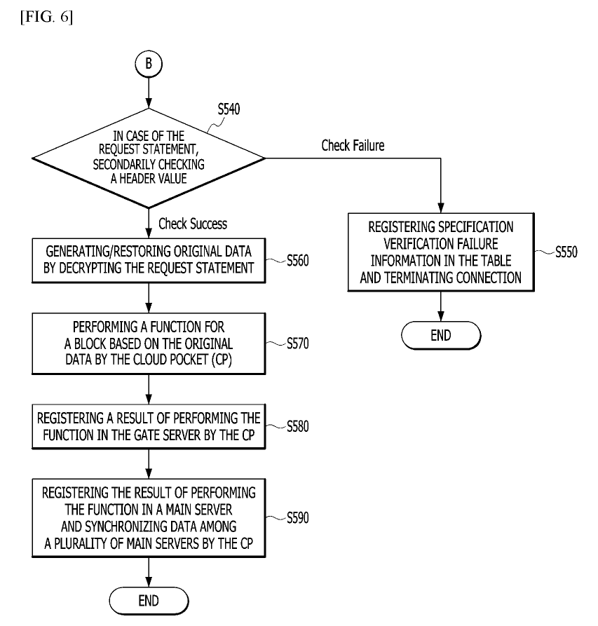

Hereinafter, a method for controlling the cloud blockchain system 10 according to the present invention will be described in detail with reference to FIGS. 1 to 6.

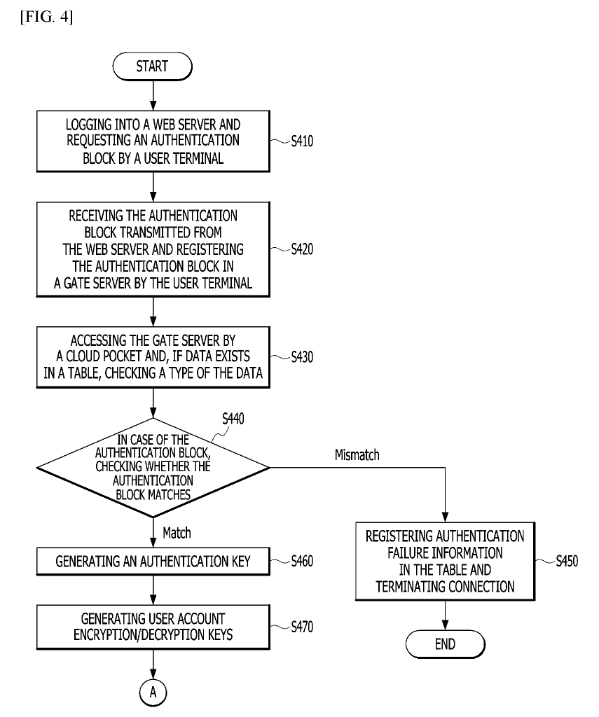

FIGS. 4 to 6 are flowcharts illustrating the method for controlling the cloud blockchain system according to an embodiment of the present invention.

First, the user terminal 100 logs in to (or accesses/connects to) a web server (not shown) using an identifier (ID) (or a device ID of the user terminal 100) and a password. In this case, the user terminal 100 may be in a state of having signed up as a member to use a service provided by the web server.

Furthermore, the user terminal 100 requests the web server to generate an authentication block according to a request of a user of the user terminal 100.

In response to the authentication block generation request (or authentication block generation request information) of the user terminal 100, the web server generates an authentication block comprising the ID (or the device ID of the user terminal 100) and the password associated with the user terminal 100, and provides (or transmits) the generated authentication block to the user terminal 100.

In addition, the web server registers (or stores) the generated authentication block in a gate server 200 (or an arbitrary table among a plurality of tables within the gate server 200) interworking with the web server. In this case, the gate server 200 registers (or stores) the authentication block provided from the web server in any one table among a plurality of tables (or a plurality of vaults) within the gate server 200.

Furthermore, the gate server 200 is configured to interwork with each of remaining gate servers 200, excluding the corresponding gate server 200 itself, among the total plurality of gate servers 200, to respectively store (or register/update) the authentication block in the remaining gate servers 200.

As an example, a first user terminal 100 logs in to a first web server (not shown) for trading virtual currency (or cryptocurrency) using a first ID and a first password of the first user terminal, and transmits first authentication block generation request information to the first web server.

Then, the first web server receives the first authentication block generation request information transmitted from the first user terminal, generates a first authentication block comprising the first ID and the first password based on the received first authentication block generation request information, and transmits the generated first authentication block to the first user terminal.

Furthermore, the first web server stores the generated first authentication block in a second gate server 200 interworking with the first web server among the plurality of gate servers 200.

As another example, a second user terminal 100 logs in to a second web server for trading virtual currency (or cryptocurrency) using a second ID and a second password of the second user terminal, and transmits second authentication block generation request information to the second web server.

Then, the second web server receives the second authentication block generation request information transmitted from the second user terminal, generates a second authentication block comprising the second ID and the second password based on the received second authentication block generation request information, and transmits the generated second authentication block to the second user terminal.

In addition, the web server stores the generated second authentication block in a 23rd gate server 200 interworking with the second web server among the plurality of gate servers 200 (S410).

Thereafter, the user terminal 100 receives the authentication block provided (or transmitted) from the web server in response to the previous authentication block generation request (or the authentication block generation request information).

Furthermore, the user terminal 100 accesses (or connects to) one specific gate server 200 among the plurality of gate servers 200 to be issued an authentication key (or an authentication key block) from the cloud pocket 300. In this case, the user terminal 100 and the gate server 200 communicate using a preset HTTP protocol (or HTTPS protocol).

In addition, the user terminal 100 registers (or stores) the received authentication block in the connected specific gate server 200.

That is, the user terminal 100 registers (or stores) the authentication block into any one specific table (or a specific vault) among a plurality of tables (or vaults) within the specific gate server 200.

As an example, the first user terminal receives the first authentication block transmitted from the first web server in response to the previous first authentication block generation request.

Then, the first user terminal accesses the second gate server among the plurality of gate servers 200.

Furthermore, the first user terminal registers the first authentication block into a second table among a plurality of tables managed by the second gate server.

As another example, the second user terminal receives the second authentication block transmitted from the second web server in response to the previous second authentication block generation request.

In addition, the second user terminal 100 accesses the 23rd gate server among the plurality of gate servers 200.

Further, the second user terminal 100 registers the second authentication block into a 23rd table among a plurality of tables managed by the 23rd gate server (S420).

Thereafter, the cloud pocket 300 connects to (or communicates with/accesses) the specific gate server 200 at a preset interval, and then checks whether data (including, for example, an authentication block and the like) is in a registered (or stored) state in a plurality of tables (or vaults) within the specific gate server 200. Here, the cloud pocket 300 is any one of a plurality of cloud pockets 300 and is in a state preset to communicate with the specific gate server 200, and a connection between the cloud pocket 300 and the specific gate server 200 may be unidirectional communication in which only the cloud pocket 300 accesses the specific gate server 200.

As a result of the checking, if the data is in a registered state in at least one table among the plurality of tables, the cloud pocket 300 confirms the data registered in the table.

That is, the cloud pocket 300 regularly accesses the specific gate server 200 at constant time intervals (or periods) while running a loop (or a thread) and checks whether there is a task (or data) to be processed by the cloud pocket 300. Here, the task to be processed by the cloud pocket 300 may be a function related to data registered in a table within the specific gate server 200 by an arbitrary user terminal 100 or the like.

As an example, a third cloud pocket 300 accesses the second gate server at a preset interval and checks whether arbitrary data is in a registered state in a plurality of tables managed by the second gate server.

As another example, the third cloud pocket 300 accesses the 23rd gate server at a preset interval and checks whether arbitrary data is in a registered state in a plurality of tables managed by the 23rd gate server (S430).

Thereafter, if the data is an authentication block, the cloud pocket 300 interworks with the specific gate server 200 to compare (or check) whether the authentication block registered in the specific gate server 200 by the web server matches the authentication block registered in the specific gate server 200 by the user terminal 100.

As an example, when the first authentication block is in a registered state in the second table managed by the second gate server, the third cloud pocket compares whether the first authentication block previously registered in the second gate server by the first web server matches the first authentication block registered in the second table of the second gate server by the first user terminal.

As another example, when the second authentication block is in a registered state in the 23rd table managed by the 23rd gate server, the third cloud pocket compares whether the second authentication block previously registered in the 23rd gate server by the second web server matches the second authentication block registered in the 23rd table of the 23rd gate server by the second user terminal (S440).

As a result of the comparison (or the check), if the authentication block registered (or stored) in the specific gate server 200 by the web server does not match the authentication block registered (or stored) in the specific gate server 200 by the user terminal 100, the cloud pocket 300 registers (or stores) authentication failure information in the table (or the vault) of the specific gate server 200, and terminates the connection with the specific gate server 200. Here, the cloud pocket 300 stores the authentication failure information in addition to data previously stored (including, for example, the authentication block and the like) in the table of the specific gate server 200, or deletes the data stored in the table and then stores the authentication failure information.

In addition, the user terminal 100 confirms (or displays/outputs) the authentication failure information registered (or stored) in the table (or the vault) of the specific gate server 200. In this case, while the user terminal 100 is in a state of being connected to the specific gate server 200, as new information (including, for example, authentication failure information) is registered in the table of the specific gate server 200, the user terminal 100 may receive notification information (or guidance information) transmitted from the specific gate server 200 and check the authentication failure information registered in the table based on the received notification information. Furthermore, the user terminal 100 may additionally display guidance information indicating that a new authentication block should be issued through the previous steps.

As an example, as a result of the comparison, if the first authentication block registered in the second gate server by the first web server does not match the first authentication block registered in the second table of the second gate server by the first user terminal, the third cloud pocket cumulatively stores the authentication failure information in the second table of the second gate server and terminates the connection with the second gate server.

In addition, the first user terminal displays the authentication failure information registered in the second table within the second gate server being accessed.

As another example, as a result of the comparison, when the second authentication block registered in the 23rd gate server by the second web server does not match the second authentication block registered in the 23rd table of the 23rd gate server by the second user terminal, the second cloud pocket stores authentication failure information in the 23rd table of the 23rd gate server and terminates the connection with the 23rd gate server.

Furthermore, the second user terminal displays the authentication failure information registered in the 23rd table within the 23rd gate server being accessed (S450).

In addition, as a result of the comparison (or the check), when the authentication block registered (or stored) in the specific gate server 200 by the web server matches the authentication block registered (or stored) in the specific gate server 200 by the user terminal 100, the cloud pocket 300 confirms the ID (or device ID), the password, and the like included in the authentication block.

Additionally, the cloud pocket 300 generates (or issues) an authentication key based on the confirmed ID, password, current time, and a preset validity period. In this case, the authentication key includes the ID (or device ID), the password, and a timestamp including validity period information for the authentication key. Here, the validity period may be a preset value (including, for example, 3 minutes, 5 minutes, 10 minutes, and the like).

As an example, when the first authentication block registered in the second gate server by the first web server matches the first authentication block registered in the second table of the second gate server by the first user terminal, the third cloud pocket confirms the first ID and the first password included in the first authentication block, and generates a first authentication key consisting of the confirmed first ID, first password, and a first timestamp. Here, the first timestamp is displayed (or managed/configured) in an integer format and may be a value (e.g., 1:15:20 PM on Mar. 1, 2025) to which a preset validity period (e.g., 5 minutes) is applied from a current time (e.g., 1:10:20 PM on Mar. 1, 2025).

As another example, when the second authentication block registered in the 23rd gate server by the second web server matches the second authentication block registered in the 23rd table of the 23rd gate server by the second user terminal, the third cloud pocket confirms the second ID and the second password included in the second authentication block, and generates a second authentication key consisting of the confirmed second ID, second password, and a second timestamp. Here, the second timestamp is displayed (or managed/configured) in an integer format and may be a value (e.g., 7:25:30 PM on Mar. 1, 2025) to which a preset validity period (e.g., 5 minutes) is applied from a current time (e.g., 7:20:30 PM on Mar. 1, 2025) (S460).

Thereafter, the cloud pocket 300 generates a user account encryption/decryption key. Here, the user account encryption/decryption key may be used in a preset state or may be generated and used upon request, and comprises (or includes) an inquiry account key (or a decryption key), a modification account key (or an encryption key), and a computation key.

Specifically, the cloud pocket 300 generates the user account encryption/decryption key, which is a byte key of a preset size (e.g., 256 bytes times 3), and the byte key indicates that the key unit is in bytes.

As an example, the third cloud pocket generates a first user account encryption/decryption key consisting of a first inquiry account key of a preset size (e.g., 256 bytes) for interpreting (or decrypting) encrypted data, a first modification account key of a preset size (e.g., 256 bytes) for encrypting data, and a first computation key of a preset size (e.g., 256 bytes) for making interpretation via patterns impossible by using a computational encoding scheme.

As another example, the third cloud pocket generates a second user account encryption/decryption key consisting of a second inquiry account key of a preset size (e.g., 256 bytes), a second modification account key of a preset size (e.g., 256 bytes), and a second computation key of a preset size (e.g., 256 bytes) (S470).

Thereafter, the cloud pocket 300 registers (or stores) an authentication key block including the generated authentication key and the generated user account encryption/decryption key in the table (or the vault) of the specific gate server 200. Here, the cloud pocket 300 stores the authentication key block in addition to data previously stored (including, for example, the authentication block and the like) in the table of the specific gate server 200, or deletes the data stored in the table and then stores the authentication key block.

Furthermore, the cloud pocket 300 interworks with one main server 400 among a plurality of main servers 400 to store (or register) the authentication key block in one record within one table among a plurality of tables in a database (not shown) of the main server 400. In this case, as the authentication key block is stored in a specific record within a specific table of the database, the cloud pocket 300 receives a vault ID (or a vault ID corresponding to the specific table) provided from the main server 400. Here, when the cloud pocket 300 stores the authentication key block in the table within the specific gate server 200 accessed at a preset interval, the cloud pocket 300 may store the vault ID together with the authentication key block.

Furthermore, the user terminal 100 checks (or displays, outputs, or downloads) the authentication key block registered (or stored) in the table (or the vault) of the specific gate server 200. In this case, while the user terminal 100 is connected to the specific gate server 200, as new information (including, for example, the authentication key block) is registered in the table, the user terminal 100 may receive notification information (or guidance information) transmitted from the specific gate server 200 and check the authentication key block registered in the table based on the received notification information.

As an example, the third cloud pocket 300 generates a first authentication key block including the generated first authentication key and the generated first user account encryption/decryption key, and cumulatively stores the first authentication key block in a second table of a second gate server.

In addition, the third cloud pocket interworks with a 14th main server 400 among a plurality of main servers 400 to store the first authentication key block in a 14th record within a 4th table in a database of the 14th main server.

Then, the 14th main server transmits a 4th vault ID, which corresponds to the 4th table where the first authentication key block is stored, to the third cloud pocket.

The third cloud pocket then receives the 4th vault ID transmitted from the 14th main server.

Subsequently, the first user terminal checks the first authentication key block registered in the second table within the second gate server being accessed, and downloads and temporarily stores the first authentication key block.

As another example, the third cloud pocket generates a second authentication key block including the generated second authentication key and the generated second user account encryption/decryption key, and stores the second authentication key block in a 23rd table of a 23rd gate server.

In addition, the third cloud pocket interworks with the 14th main server 400 to store the second authentication key block in a 34th record within a 34th table in the database of the 14th main server.

Then, the 14th main server transmits a 34th vault ID corresponding to the 34th table to the third cloud pocket.

The third cloud pocket then receives the 34th vault ID transmitted from the 14th main server.

In addition, the second user terminal checks the second authentication key block registered in the 23rd table within the accessed 23rd gate server, and downloads and temporarily stores the second authentication key block (S480).

Thereafter, in order to store (or generate/modify) data (or information) in a cloud blockchain managed by the cloud pocket 300 or to inquire about data (or information) registered in the cloud blockchain, the user terminal 100 encrypts original data to be registered in the cloud blockchain using the user account encryption/decryption key included in the authentication key block, thereby generating an encrypted block (or encrypted data). Here, the original data (or a target block/target data/data block to be encrypted) includes not only content (or information/data) but also a requirement (including, for example, generation request information, modification request information, inquiry request information, and the like). Further, the encrypted block may include a header value (or a header value related to encryption) in addition to the original data.

As an example, the first user terminal generates a first encrypted block by encrypting first original data (for example, "I want to know the total amount in my wallet"), which includes information for checking a balance in a cryptocurrency wallet associated with a person who is a first user of the first user terminal, using a first user account encryption/decryption key included in the first authentication key block.

As another example, the second user terminal generates a second encrypted block by encrypting second original data (for example, "Transfer 1 Bitcoin from the Bitcoins in my wallet to another person's cryptocurrency wallet"), which includes information for transferring 1 Bitcoin kept in a cryptocurrency wallet of another person who is a second user of the second user terminal to the cryptocurrency wallet of the person, using a second user account encryption/decryption key included in the second authentication key block (S490).

Thereafter, the user terminal 100 generates a request statement (or a command statement/request statement/request statement block) including the generated encrypted block, the authentication key included in the authentication key block, and the like.

Additionally, the user terminal 100 accesses (or communicates with/connects to) a specific gate server 200 among the plurality of gate servers 200.

Furthermore, the user terminal 100 registers (or stores) the generated request statement in the connected specific gate server 200.

That is, the user terminal 100 registers (or stores) the request statement in any one other specific table (or another specific vault) among a plurality of tables (or vaults) within the specific gate server 200.

As an example, the first user terminal generates a first request statement including the generated first encrypted block, the first authentication key included in the first authentication key block, and the like.

Then, the first user terminal accesses the second gate server among the plurality of gate servers 200 and registers the generated first request statement in a second table among a plurality of tables managed by the accessed second gate server.

As another example, the second user terminal generates a second request statement including the generated second encrypted block, the second authentication key included in the second authentication key block, and the like.

Then, the second user terminal accesses the 23rd gate server among the plurality of gate servers 200 and registers the generated second request statement in a 24th table among a plurality of tables managed by the accessed 23rd gate server (S500).

Thereafter, the cloud pocket 300 connects to (or communicates with/accesses) the specific gate server 200 at the preset interval, and then checks whether data (including, for example, a request statement) is in a registered (or stored) state in a plurality of tables (or vaults) within the specific gate server 200.

As a result of the checking, if the data is in a registered state in at least one table (or vault) among the plurality of tables (or vaults), the cloud pocket 300 confirms the data registered in the table (or vault).

That is, the cloud pocket 300 regularly accesses the specific gate server 200 at constant time intervals (or cycles) while running a loop (or a thread) and checks whether there is a task (or data) to be processed by the cloud pocket 300. Here, the task to be processed by the cloud pocket 300 may be a function related to data registered in a table within the specific gate server 200 by an arbitrary user terminal 100 or the like.

As an example, a third cloud pocket 300 accesses the second gate server at a preset interval and checks whether arbitrary data is in a registered state in a plurality of tables managed by the second gate server.

As another example, the third cloud pocket 300 accesses the 23rd gate server at a preset interval and checks whether arbitrary data is in a registered state in a plurality of tables managed by the 23rd gate server (S510).

Thereafter, if the data is a request statement, the cloud pocket 300 primarily verifies (or determines) validity of the data (or the request statement) based on a timestamp included in the request statement.

That is, when the data is a request statement, the cloud pocket 300 verifies (or determines) whether a time difference between a current time and a timestamp included in the request statement has passed (or exceeded) a preset reference value (including, for example, 3 seconds, 5 seconds, 10 seconds, and the like) based on the current time and the timestamp, in order to verify the validity of the data (or the request statement).

As an example, when the first request statement is in a registered state in the second table among the plurality of tables managed by the second gate server, the third cloud pocket calculates a first time difference between the current time and a first timestamp (e.g., 1:15:20 PM on March 1, 2025) included in the first request statement, and determines whether the calculated first time difference has passed a preset first reference value (e.g., 5 seconds).

As another example, when the second request statement is in a registered state in the 24th table among the plurality of tables managed by the 23rd gate server, the third cloud pocket calculates a second time difference between the current time and a second timestamp (e.g., 7:25:30 PM on Mar. 1, 2025) included in the second request statement, and determines whether the calculated second time difference has passed a preset second reference value (e.g., 3 seconds) (S520).

As a result of the validity verification of the data (or the result of determining the validity of the data/request statement), if the request statement is determined to be invalid, the cloud pocket 300 registers (or stores) information indicating that the validity verification of the data has failed in the corresponding table (or vault) of the specific gate server 200, and terminates the connection with the specific gate server 200. Here, the cloud pocket 300 stores the information indicating the failure of the validity verification in addition to data previously stored (including, for example, an authentication block, a request statement, and the like) in the table of the specific gate server 200, or deletes the data stored in the table and then stores the information indicating the failure of the validity verification.

Specifically, if the time difference between the current time and the timestamp included in the request statement has passed (or exceeded) the preset reference value (including, for example, 3 seconds, 5 seconds, 10 seconds, and the like), the cloud pocket 300 registers (or stores) the information indicating that the validity verification of the data has failed in the corresponding table (or vault) of the specific gate server 200, and terminates the connection with the specific gate server 200.

In addition, the user terminal 100 checks (or displays/outputs) information indicating that the validity verification of the corresponding data registered (or stored) in the corresponding table (or vault) of the specific gate server 200 has failed. In this case, while the user terminal 100 is in a state of being connected to the specific gate server 200, as new information (including, for example, information indicating that the validity verification of the data has failed) is newly registered in the corresponding table of the specific gate server 200, the user terminal 100 receives other notification information (or other guidance information) transmitted from the specific gate server 200. The user terminal 100 may then check the information indicating that the validity verification of the data registered in the table of the specific gate server 200 has failed based on the received other guidance information. Furthermore, the user terminal 100 may additionally display guidance information indicating that a new authentication key should be issued through the previous steps.

As an example, as a result of the validity determination for the first request statement, when the first time difference has passed the preset first reference value (e.g., 5 seconds), the third cloud pocket 300 cumulatively stores information indicating that the validity verification of the first request statement has failed in the second table of the second gate server, and terminates the connection with the second gate server.

Additionally, the first user terminal displays the information indicating that the validity verification of the first request statement registered in the second table within the accessed second gate server has failed.

As another example, as a result of the validity determination for the second request statement, when the calculated second time difference has passed the preset second reference value (e.g., 3 seconds), the third cloud pocket stores information indicating that the validity verification of the second request statement has failed in the 24th table of the 23rd gate server, and terminates the connection with the 23rd gate server.

Also, the second user terminal displays the information indicating that the validity verification of the second request statement registered in the 24th table within the accessed 23rd gate server has failed (S530).

In addition, as a result of the validity verification of the data (or the result of determining the validity of the data/request statement), if the request statement is determined to be valid, the cloud pocket 300 secondarily checks (or determines) whether a header value included in the request statement matches (or satisfies) a preset specification (or condition). Here, the header value may be a value generated in a process of encrypting an encrypted block included in the request statement.

Specifically, if the time difference between the current time and the timestamp included in the request statement has not passed (or has not exceeded) the preset reference value (including, for example, 3 seconds, 5 seconds, 10 seconds, and the like), the cloud pocket 300 determines that the request statement is valid, and secondarily checks (or determines) whether a header value included in the request statement matches (or satisfies) a preset specification (or condition).

As an example, as a result of the validity determination for the first request statement, when the first time difference has not passed the preset first reference value (e.g., 5 seconds), the third cloud pocket 300 checks whether a first header value included in the first request statement matches the preset specification.

As another example, as a result of the validity determination for the second request statement, when the calculated second time difference has not passed the preset second reference value (e.g., 3 seconds), the third cloud pocket checks whether a second header value included in the second request statement matches the preset specification (S540).

As a result of the check (or the determination), if the header value included in the request statement does not match (or satisfy) the preset specification (or condition), the cloud pocket 300 registers (or stores) information indicating that the specification verification of the data has failed in the corresponding table (or vault) of the specific gate server 200, and terminates the connection with the specific gate server 200. Here, the cloud pocket 300 stores the information indicating that the specification verification of the data has failed in addition to data previously stored (including, for example, an authentication block, a request statement, and the like) in the table of the specific gate server 200, or deletes the data stored in the table and then stores the information indicating that the specification verification of the data has failed.

Furthermore, the user terminal 100 checks (or displays/outputs) the information indicating that the specification verification of the data registered (or stored) in the corresponding table (or vault) of the specific gate server 200 has failed. In this case, while the user terminal 100 is in a state of being connected to the specific gate server 200, as new information (including, for example, the information indicating that the specification verification of the data has failed) is newly registered in the table of the specific gate server 200, the user terminal 100 receives other notification information (or other guidance information) transmitted from the specific gate server 200. The user terminal 100 may then check the information indicating that the specification verification of the data has failed based on the received other guidance information. In addition, the user terminal 100 may additionally display guidance information indicating that a new authentication key must be issued through previous steps.

As an example, when the first header value included in the first request statement does not satisfy the preset specification, the third cloud pocket 300 cumulatively stores information indicating that the specification verification of the first request statement has failed in the second table of the second gate server, and terminates the connection with the second gate server.

In addition, the first user terminal displays the information indicating that the specification verification of the first request statement, which is registered in the second table within the accessed second gate server, has failed.

As another example, when the second header value included in the second request statement does not satisfy the preset specification, the third cloud pocket stores information indicating that the specification verification of the second request statement has failed in the 24th table of the 23rd gate server, and terminates the connection with the 23rd gate server.

Further, the second user terminal displays the information indicating that the specification verification of the second request statement registered in the 24th table within the accessed 23rd gate server has failed (S550).

Furthermore, as a result of the checking (or the result of the determining), when a header value included in a request statement matches (or satisfies) a preset specification (or condition), the cloud pocket 300 tertiarily decrypts an encrypted block included in the request statement using a preset user account encryption/decryption key (or the user account encryption/decryption key previously generated based on the authentication block associated with the user terminal 100) to generate (or restore) original data.

That is, as a result of the secondary specification verification of the data, when the header value included in the request statement matches (or satisfies) the preset specification (or condition), the cloud pocket 300 separates the request statement into an authentication key and an encrypted block, and decrypts the separated encrypted block using the user account encryption/decryption key to generate (or restore) the original data.

As an example, when the first header value included in the first request statement satisfies the preset specification, the third cloud pocket separates the first request statement into the first authentication key and the first encrypted block.

In addition, the third cloud pocket decrypts the separated first encrypted block using the first user account encryption/decryption key to generate the first original data (for example, "I want to know the total amount in my wallet").

As another example, when the second header value included in the second request statement satisfies the preset specification, the third cloud pocket separates the second request statement into the second authentication key and the second encrypted block.

In addition, the third cloud pocket 300 decrypts the separated second encrypted block using the second user account encryption/decryption key to generate the second original data (for example, "Transfer 1 Bitcoin from the Bitcoins in my wallet to a specific person's cryptocurrency wallet") (S560).

Thereafter, the cloud pocket 300 performs a block generation function, a block modification function, a block inquiry function (or a block content inquiry function), and the like in a cloud blockchain based on the original data.

That is, the cloud pocket 300 performs parsing on the original data and identifies a meaning (or content) of the original data according to the parsing (or a result of the parsing).

Furthermore, when a requirement included in the request statement is a new block generation request (or when the identified meaning/content is a new block generation request), the cloud pocket 300 checks whether block generation is to be performed in the cloud pocket 300 among a pocket server list managed by the cloud pocket 300.

Specifically, the cloud pocket 300 checks, through the pocket server list, whether the new block generation request is a task (or function) to be performed in the cloud pocket 300, which is a local server. Here, the pocket server list includes information on which cloud pocket 300 a wallet (or a cryptocurrency/virtual currency wallet) corresponding to a user account is stored (or managed) in, and includes cloud pocket information (or an address/URL of the cloud pocket 300) for each piece of wallet information.

As a result of the checking, if the block generation is to be performed in the cloud pocket 300, the cloud pocket 300 performs the block generation function in the cloud blockchain based on the original data.

Specifically, when it is confirmed as a result of the checking that the new block generation request is a task (or function) to be performed in the cloud pocket 300, which is the local server that has checked the request statement, the cloud pocket 300 performs the block generation function based on the original data in the cloud pocket 300. In this case, the cloud pocket 300 may perform a block generation function of newly creating a user's wallet associated with the request statement and managing information associated with the newly created wallet.

In addition, the cloud pocket 300 updates a result of performing the block generation function associated with new block generation (or updates according to the new block generation in the cloud blockchain).

Furthermore, the cloud pocket 300 updates the result of performing the block generation function related to the new block generation in each of the remaining cloud pockets 300, excluding the cloud pocket 300 itself among all the cloud pockets 300, by using threads.

In addition, as a result of the checking, in the case where the block generation is to be performed in another cloud pocket 300 (or in the case where the block generation is not in the local server that checked the request statement), the cloud pocket 300 identifies another cloud pocket 300 in charge of performing the block generation function based on the pocket server list managed by the cloud pocket 300, and provides the request statement (or the original data) to the identified another cloud pocket 300.

Accordingly, the other cloud pocket 300 performs the block generation function in the cloud blockchain based on the request statement (or the original data). In this case, the other cloud pocket 300 may perform a block generation function of newly creating a user's wallet associated with the request statement and managing information associated with the newly created wallet.

Furthermore, after completing the performance of the block generation function, the cloud pocket 300 updates a result of performing the block generation function related to the new block generation (or a result of performing the block generation function related to the new block generation in the other cloud pocket 300) (or updates according to the new block generation in the cloud blockchain). In this case, the cloud pocket 300 may update result information regarding the newly created user's wallet according to the request statement.

Additionally, the cloud pocket 300 updates the results of performing the block generation function related to the new block generation in each of the remaining cloud pockets 300, excluding the cloud pocket 300 itself among all the cloud pockets 300, by using threads.

Furthermore, when a requirement included in the request statement is a block modification request (or when the identified meaning is a block modification request), the cloud pocket 300 checks whether a primary modification cloud pocket 300 is local based on the pocket server list managed by the cloud pocket 300.

That is, regarding the block modification request, the cloud pocket 300 checks, through the pocket server list, whether the primary modification cloud pocket 300 is a task (or function) to be performed in the cloud pocket 300, which is the local server.

As a result of the checking, when the primary modification is to be performed in the cloud pocket 300, the cloud pocket 300 performs a primary block modification function in the cloud blockchain based on the original data. Here, the primary block modification function indicates a block modification function targeting a target party.

That is, when it is confirmed that the primary modification cloud pocket 300 is a task (or function) to be performed in the cloud pocket 300, which is the local server that checked the request statement, the cloud pocket 300 performs a primary block modification function in the cloud blockchain based on the original data. In this case, the cloud pocket 300 may perform a block modification function of deducting an amount of cryptocurrency included in the request statement from a user's wallet associated with the request statement.

Furthermore, as a result of the checking, in the case where the primary modification is to be performed in another cloud pocket 300 (or in the case where the primary block modification is not in the local server that checked the request statement), the cloud pocket 300 identifies another cloud pocket 300 in charge of performing the primary block modification function based on the pocket server list managed in the cloud pocket 300, and provides the request statement (or the original data) to the identified another cloud pocket 300.

Accordingly, the other cloud pocket 300 performs the primary block modification function in the cloud blockchain based on the request statement (or the original data). In this case, the other cloud pocket 300 may perform a block modification function of deducting the amount of cryptocurrency included in the request statement from the user's wallet associated with the request statement.

In addition, the cloud pocket 300 interworks with the other cloud pocket 300 to ascertain (or confirm) whether the performance of the primary block modification function in the other cloud pocket 300 is completed.

Furthermore, after the primary block modification function is completed, the cloud pocket 300 checks whether a secondary modification cloud pocket 300 is local based on the pocket server list managed in the cloud pocket 300.

That is, regarding the block modification request, the cloud pocket 300 determines, through the pocket server list, whether the secondary modification cloud pocket 300 is a task (or function) to be performed in the cloud pocket 300, which is the local server.

As a result of the determination, when the secondary modification is to be performed in the cloud pocket 300, the cloud pocket 300 performs a secondary block modification function in the cloud blockchain based on the original data. Here, the secondary block modification function indicates a block modification function targeting a counterparty (or a recipient party).

Specifically, when it is determined that the secondary modification cloud pocket 300 is a task (or function) to be performed in the cloud pocket 300, which is the local server that has checked the request statement, the cloud pocket 300 performs the secondary block modification function in the cloud blockchain based on the original data. In this case, the other cloud pocket 300 (or the local cloud pocket 300) may perform a block modification function of deducting the amount of cryptocurrency included in the request statement from the user's wallet associated with the request statement.

Furthermore, as a result of the determination, in the case where the secondary modification is to be performed in another cloud pocket 300 (or in the case where the secondary block modification is not in the local server that checked the request statement), the cloud pocket 300 identifies another cloud pocket 300 (specifically, a different cloud pocket from the one used in the primary modification) in charge of performing the secondary block modification function based on the pocket server list managed in the cloud pocket 300, and provides the request statement (or the original data) to the identified another cloud pocket 300.

Accordingly, the other cloud pocket 300 performs the secondary block modification function in the cloud blockchain based on the request statement (or the original data). In this case, the other cloud pocket 300 may perform a block modification function of deducting an amount of cryptocurrency included in the request statement from a user's wallet associated with the request statement.

In addition, the cloud pocket 300 interworks with the other cloud pocket 300 to ascertain (or confirm) whether the performance of the secondary block modification function in the other cloud pocket 300 is completed.

Furthermore, after completing the performance of the primary and secondary block modification functions, the cloud pocket 300 updates a result of performing the block modification function related to the block modification (e.g., results from the local cloud pocket 300, the other cloud pocket 300, etc.) (or updates according to the block modification in the cloud blockchain). In this case, the cloud pocket 300 may update result information regarding changes in the wallets of the target party and the counterparty according to the transfer of cryptocurrency based on the request statement.

Additionally, the cloud pocket 300 updates the results of performing the block modification function related to the block modification in each of remaining cloud pockets 300, excluding the cloud pocket 300 itself among all the cloud pockets 300, by using threads.

Furthermore, when a requirement included in the request statement is a block inquiry request (or when the identified meaning is a block inquiry request), the cloud pocket 300 checks whether the block inquiry is to be performed in the cloud pocket 300 among the pocket server list managed by the cloud pocket 300.

That is, the cloud pocket 300 checks, through the pocket server list, whether the block inquiry request is a task (or function) to be performed in the cloud pocket 300, which is the local server.

As a result of the checking, if the block inquiry is to be performed in the cloud pocket 300, the cloud pocket 300 performs a function of checking information (or information/data within a block) corresponding to the block inquiry request in the cloud blockchain.

Specifically, when it is confirmed that the block inquiry request is a task (or function) to be performed in the cloud pocket 300, which is the local server that has checked the request statement, the cloud pocket 300 performs a block inquiry function based on the original data in the cloud blockchain. In this case, the cloud pocket 300 may perform an inquiry function of checking a balance remaining in a user's wallet associated with the request statement.

Furthermore, the cloud pocket 300 updates a result of performing the block inquiry function (or updates according to the block inquiry in the cloud blockchain).

In addition, the cloud pocket 300 updates the results of performing the block inquiry function in each of remaining cloud pockets 300, excluding the cloud pocket 300 itself among all the cloud pockets 300, by using threads.

Moreover, as a result of the checking, in the case of a block inquiry in another cloud pocket 300 (or in the case where the block inquiry is not in the local server that checked the request statement), the cloud pocket 300 identifies another cloud pocket 300 in charge of performing the block inquiry function based on the pocket server list managed in the cloud pocket 300, and provides the request statement (or the original data) to the identified another cloud pocket 300.

Accordingly, the other cloud pocket 300 performs the block inquiry function in the cloud blockchain based on the request statement (or the original data). In this case, the other cloud pocket 300 may perform the inquiry function of checking the balance remaining in the user's wallet associated with the request statement.

Furthermore, after completing the performance of the block inquiry function, the cloud pocket 300 updates the result of performing the block inquiry function (or the result of performing the block inquiry function related to the block inquiry in the other cloud pocket 300) (or an update according to the block inquiry in the cloud blockchain). In this case, the cloud pocket 300 may update information regarding the balance remaining in the user's wallet according to the request statement.

Additionally, the cloud pocket 300 updates the results of performing the block inquiry function in each of the remaining cloud pockets 300, excluding the cloud pocket 300 itself among all the cloud pockets 300, by using threads.

As an example, the third cloud pocket performs parsing on the first original data included in the first request statement, and identifies a first meaning (e.g., a balance inquiry) of the first original data (e.g., "I want to know the total amount in my wallet") according to the parsing.

Furthermore, when the first requirement included in the first request statement is a block inquiry, the third cloud pocket checks, through a third pocket server list managed by the third cloud pocket, whether the block inquiry is to be performed in the third cloud pocket (or whether a person's cryptocurrency wallet associated with the first request statement is set in the third cloud pocket).

As a result of the checking, if it is a block inquiry in the third cloud pocket (or the person's cryptocurrency wallet is set in the third cloud pocket), the third cloud pocket confirms fourth data (e.g., "the balance is 0.5 Bitcoin in the person's wallet") corresponding to the block inquiry request in the cloud blockchain.

In addition, the third cloud pocket updates a result of performing the block inquiry function related to the block inquiry.

Furthermore, the third cloud pocket updates the result of performing the block inquiry function in each of the remaining cloud pockets 300, excluding the third cloud pocket itself among all the cloud pockets 300, by using threads.

As another example, the third cloud pocket performs parsing on the second original data included in the second request statement, and identifies a second meaning (e.g., block modification) of the second original data (e.g., "Transfer 1 Bitcoin from the Bitcoins in my wallet to a specific person's cryptocurrency wallet") according to the parsing.

Furthermore, when the identified second meaning is block modification, the third cloud pocket checks, through the third pocket server list managed by the third cloud pocket, whether a primary modification related to the block modification request is a task to be performed in the local server (or checks whether another person's cryptocurrency wallet for the transfer is set in the third cloud pocket).

As a result of the checking, when the primary modification is to be performed in the third cloud pocket (or when the other person's cryptocurrency wallet for the transfer is set in the third cloud pocket), the third cloud pocket performs a primary block modification function (e.g., a block modification function by deducting 1 Bitcoin from the wallet associated with the other person) based on the second original data in the cloud blockchain.

In addition, the third cloud pocket 300 determines, based on the pocket server list managed in the third cloud pocket, whether a secondary modification related to the block modification request is a task to be performed in the local server (or determines whether the cryptocurrency wallet of the specific person, who is the recipient, is in a state set in the third cloud pocket).

As a result of the determination, when the secondary modification is to be performed in another cloud pocket, the third cloud pocket identifies a seventh cloud pocket 300 in charge of performing the secondary block modification function based on the pocket server list managed in the third cloud pocket, and transmits the second request statement (or the second original data) to the identified seventh cloud pocket.

Furthermore, the seventh cloud pocket receives the second request statement (or the second original data) transmitted from the third cloud pocket, and performs the secondary block modification function (e.g., a block modification function by adding 1 Bitcoin to the wallet associated with the specific person) based on the received second request statement (or second original data).

In addition, the third cloud pocket updates a result of performing the block modification function related to the block modification.

Further, the third cloud pocket updates the result of performing the block modification function in each of the remaining cloud pockets 300, excluding the third cloud pocket itself among all the cloud pockets 300, by using threads (S570).

Thereafter, the cloud pocket 300 connects to (or communicates with/accesses) the specific gate server 200 at a preset interval, and then registers (or stores) a result of performing a function (including, for example, a result of performing a block generation function, a block modification function, a block inquiry function, and the like) corresponding to the request statement into the corresponding table (or vault) of the specific gate server 200. Here, the cloud pocket 300 stores the result of performing the function in the table within the specific gate server 200 where data (including, for example, an authentication block, an authentication key block, a request statement, and the like) was previously registered in relation to the user terminal 100, or deletes data being stored in the table and then stores the result of performing the function corresponding to the request statement.

Furthermore, the user terminal 100 checks (or displays/outputs) the result of performing the function registered (or stored) in the corresponding table (or vault) of the specific gate server 200. In this case, while the user terminal 100 is in a state of being connected to the specific gate server 200, as new information (including, for example, the result of performing the function) is newly registered in the corresponding table of the specific gate server 200, the user terminal 100 may receive notification information (or guidance information) transmitted from the specific gate server 200 and check the result of performing the function registered in the table based on the received notification information.

As an example, the third cloud pocket 300 accesses the second gate server at a preset interval, and cumulatively stores a result of performing a block inquiry function (e.g., Chul-soo's wallet balance is 0.5 Bitcoin) in a second table of the second gate server.

In addition, the first user terminal 100 displays the result of performing the block inquiry function (e.g., Chul-soo's wallet balance is 0.5 Bitcoin) stored in the second table within the accessed second gate server.

As another example, the third cloud pocket 300 accesses the 23rd gate server at a preset interval, and stores a result of performing a block modification function (e.g., 1 Bitcoin was normally transferred from Young-hee's wallet to Hong Gil-dong, and Young-hee's wallet balance is 12 Bitcoins) in a 24th table of the 23rd gate server.

Furthermore, the second user terminal 100 displays the result of performing the block modification function (e.g., 1 Bitcoin was normally transferred from Young-hee's wallet to Hong Gil-dong, and Young-hee's wallet balance is 12 Bitcoins) stored in the 24th table within the accessed 23rd gate server (S580).

Thereafter, the cloud pocket 300 connects to (or accesses/communicates with) any one main server 400 among a plurality of main servers 400, and stores (or registers) a result of performing a function (including, for example, a result of performing a block generation function, a block modification function, a block inquiry function, and the like) in a specific table within a database (not shown) inside the connected main server 400. Here, the connection between the cloud pocket 300 and the main server 400 is configured as bidirectional communication, and they communicate using a preset TCP/IP protocol. In this case, the corresponding TCP/IP protocol is custom-developed, and protocol information thereof is private (or non-disclosed).

Furthermore, the cloud pocket 300 receives a specific vault ID related to the specific table in which the corresponding result of performing the function is stored, provided from the main server 400.

In addition, the cloud pocket 300 connects to (or communicates with/accesses) the corresponding specific gate server 200 at a preset interval, and then registers (or stores) the specific vault ID in the corresponding table (or vault) of the specific gate server 200. Here, the cloud pocket 300 may cumulatively store the specific vault ID in the table (or vault) among a plurality of tables (or vaults) within the specific gate server 200 where data (including, for example, an authentication block, an authentication key block, a request statement, and the like) was previously registered in relation to the user terminal 100, or may initialize the corresponding table and store the specific vault ID. In this case, the cloud pocket 300 may respectively store the authentication block, the authentication key block, the request statement, the specific vault ID, and the like in different tables among the plurality of tables of the specific gate server 200.

Furthermore, the main server 400 interworks with each of the remaining main servers 400, excluding the corresponding one main server 400 among the plurality of main servers 400, to respectively store (or register/update) the functional result (including, for example, a block generation result, a block modification result, a block inquiry result, and the like) in databases respectively configured in the remaining main servers 400.

In addition, the user terminal 100 checks (or displays/outputs) a specific vault ID registered (or stored) in the corresponding table (or vault) of the specific gate server 200.

Additionally, the user terminal 100 uses the specific vault ID when it intends to perform a modification function, an inquiry function, or the like regarding information (or data) related to the corresponding case in the future.

As an example, the third cloud pocket 300 connects to a fourth main server among the plurality of main servers 400 and transmits the block inquiry result to the connected fourth main server.

Then, the fourth main server receives the block inquiry result transmitted from the third cloud pocket.

The fourth main server stores the received block inquiry result in a 44th table among a plurality of tables managed by the fourth main server, and transmits a 44th vault ID, which corresponds to the 44th table where the block inquiry result is stored, to the third cloud pocket.

Furthermore, the fourth main server interworks with all remaining main servers 400, excluding the fourth main server itself, to share the block inquiry result so that each of the remaining main servers 400 respectively stores the block inquiry result.

The third cloud pocket receives the 44th vault ID transmitted from the fourth main server.

After connecting to the second gate server at a preset interval, the third cloud pocket stores the 44th vault ID in a second table among a plurality of tables within the second gate server. In this case, the third cloud pocket updates the 44th vault ID in each of the remaining cloud pockets 300, excluding the third cloud pocket itself among all the cloud pockets 300, by using threads.

In addition, the first user terminal displays the 44th vault ID registered in the second table within the accessed second gate server.

As another example, the third cloud pocket 300 connects to a fourth main server among the plurality of main servers 400 and transmits the result of performing a block modification function to the connected fourth main server.

Furthermore, the fourth main server receives the result of performing the block modification function transmitted from the third cloud pocket.

In addition, the fourth main server stores the received result of performing the block modification function in a 55th table among a plurality of tables managed by the fourth main server, and transmits a 55th vault ID (corresponding to the 55th table where the result is stored) to the third cloud pocket.

The fourth main server also interworks with all remaining main servers 400, excluding the fourth main server itself, to share the result of performing the block modification function so that each of the remaining main servers 400 respectively stores the result.

The third cloud pocket receives the 55th vault ID transmitted from the fourth main server.

After connecting to the 23rd gate server at a preset interval, the third cloud pocket stores the 55th vault ID in a 24th table among a plurality of tables within the 23rd gate server. In this case, the third cloud pocket updates the 55th vault ID in each of the remaining cloud pockets 300, excluding the third cloud pocket itself among all the cloud pockets 300, by using threads.

The second user terminal then displays the 55th vault ID registered in the 24th table within the accessed 23rd gate server (S590).

As described above, according to an embodiment of the present invention, the user terminal 100 encrypts original data using an authentication key to generate an encrypted block, and registers request information (including the encrypted block and a timestamp) into the gate server 200. The cloud pocket 300 then accesses the gate server 200 to confirm the request information, decrypts the encrypted block included in the request information to restore the original data, and stores the original data as a new block in the blockchain or modifies existing data with the original data.

By configuring the blockchain in cloud pockets 300 connected to a network rather than on a personal PC or device, no information is stored on the personal device. In a state where only an encrypted block protocol connecting the user and the cloud pocket 300 exists, numerous cloud pockets are connected to each other in a P2P (Peer-to-Peer) manner on the network. This enables monetary functions through real-time processing, allowing for real-time modification, transmission, and generation, as well as enabling control over the money supply and tracking the flow of virtual currency.

Furthermore, as described above, according to an embodiment of the present invention, after a user terminal logs into a web server using an ID and a password, the user terminal receives an authentication block provided by the web server upon request and registers the received authentication block in a gate server. Subsequently, a cloud pocket confirms authentication by checking whether the authentication block registered in the gate server by the user terminal matches an authentication block registered in the gate server by the web server. If the authentication is successful, the cloud pocket generates an authentication key for which a validity period is set and registers the generated authentication key in the gate server. Thereafter, the user terminal interworks with the gate server and the cloud pocket using the authentication key registered in the gate server to register original data in a cloud blockchain in a block format. Accordingly, the user terminal can efficiently perform block generation, modification, and the like using the authentication key for which the validity period is set.

In the detailed description of the present invention above, only specific embodiments thereof have been described. However, it should be understood that the present invention is not limited to the specific forms described in the detailed description, but rather includes all modifications, equivalents, and alternatives falling within the spirit and scope of the present invention defined by the appended claims.

That is, the present invention is not limited to the above-described specific exemplary embodiments. Those skilled in the art may variously modify the present invention without departing from the gist of the present invention claimed by the appended claims and the modifications are within the scope of the claims.

What is claimed is:

1. A cloud blockchain system, comprising:
a gate server;
a user terminal; and
a cloud pocket;
wherein the gate server is configured to mediate between the user terminal and the cloud pocket;
wherein the user terminal is configured to access a gate server among a plurality of gate servers to be issued an authentication key from the cloud pocket, register an authentication block provided by a web server into one of a plurality of tables within the gate server, and receive an authentication key block corresponding to the registered authentication block;
wherein the cloud pocket is configured to access the gate server at a preset interval and check whether data is registered in the plurality of tables, verify registered data when at least one of the plurality of tables contains data, if the verified data is the authentication block, compare the authentication block registered by the web server on the gate server with the authentication block registered by the user terminal on the gate server for consistency by interworking with the gate server, if the comparison results in a match, verify an identifier (ID) and a password included in the authentication block, and generate the authentication key based on the verified ID, the password, a current time, and a preset expiration period, generate a user account encryption/decryption key comprising a inquiry account key, a modification account key, and an computation key, and register the authentication key block, including the generated authentication key and the generated user account encryption/decryption key, into a table of the gate server;
wherein the user terminal is further configured to log into the web server using the ID and the password;
wherein the web server is configured to generate the authentication block comprising the ID and the password based on an authentication block generation request from the user terminal, transmit the generated authentication block to the user terminal, and register the generated authentication block on the gate server interworking with the web server;
wherein the user terminal is further configured to receive the authentication block transmitted from the web server in response to the authentication block generation request; and
wherein a connection between the cloud pocket and the gate server is a unidirectional communication in which only the cloud pocket accesses the gate server.

2. A method for controlling a cloud blockchain system, comprising:
accessing, by a user terminal, a gate server among a plurality of gate servers to be issued an authentication key from a cloud pocket;
registering, by the user terminal, an authentication block provided by a web server into one of a plurality of tables within the gate server;
accessing, by the cloud pocket, the gate server at a preset interval to check whether data is registered in the plurality of tables;
verifying, by the cloud pocket, registered data when it is determined that at least one of the plurality of tables is in a state where data is registered;
comparing, by the cloud pocket, the authentication block registered by the web server on the gate server with the authentication block registered by the user terminal on the gate server for consistency by interworking with the gate server, when the verified data is the authentication block;
verifying an identifier (ID) and a password included in the authentication block and generating, by the cloud pocket, the authentication key based on the verified ID, the password, a current time, and a preset expiration period, when the authentication block registered by the web server matches the authentication block registered by the user terminal;
generating, by the cloud pocket, a user account encryption/decryption key comprising a inquiry account key of a preset size for interpreting encrypted data, a modification account key of a preset size for encrypting data, and an computation key of a preset size configured to prevent pattern interpretation using an arithmetic coding method;
registering, by the cloud pocket, an authentication key block comprising the generated authentication key and the generated user account encryption/decryption key into the table of the gate server; and
confirming, by the user terminal, the authentication key block registered in the table of the gate server;
wherein the user terminal logs into the web server using the ID and the password;
wherein the web server is configured to generate the authentication block comprising the ID and the password based on an authentication block generation request from the user terminal, transmit the generated authentication block to the user terminal, and register the generated authentication block on the gate server interworking with the web server;
wherein the user terminal receives the authentication block transmitted from the web server in response to the authentication block generation request; and
wherein a connection between the cloud pocket and the gate server is a unidirectional communication in which only the cloud pocket accesses the gate server.

3. The method of claim 2, further comprising:
generating, by the user terminal, an encrypted block by encrypting original data to be registered in the cloud blockchain managed by the cloud pocket using the user account encryption/decryption key included in the authentication key block, in order to store data in the cloud blockchain or to query data registered in the cloud blockchain;
generating, by the user terminal, a request statement comprising the generated encrypted block and the authentication key included in the authentication key block;
accessing, by the user terminal, the gate server;
registering, by the user terminal, the generated request statement into one of the plurality of tables within the gate server;
accessing, by the cloud pocket, the gate server at the preset interval and checking whether data is registered in the plurality of tables within the gate server;
verifying, by the cloud pocket, the registered data when it is determined that at least one of the plurality of tables is in a state where data is registered;
performing, by the cloud pocket, a verification function on the request statement, when the verified data is the request statement; and
performing, by the cloud pocket, any one of a block generation function, a block modification function, and a block inquiry function in the cloud blockchain based on the original data decrypted from the request statement, when the verification of the request statement is successfully completed.

4. The method of claim 3, wherein the performing of the verification function on the request statement comprises:
verifying, by the cloud pocket, whether a time difference between a current time and a timestamp included in the request statement exceeds a preset reference value to validate the data;
registering, by the cloud pocket, information indicating that validity verification of the data has failed into the table of the gate server and terminating a connection with the gate server, when the request statement is determined to be invalid as a result of the validity verification;
verifying, by the cloud pocket, whether a header value included in the request statement satisfies a preset specification, when the request statement is determined to be valid as a result of the validity verification; and
generating the original data by decrypting, by the cloud pocket, the encrypted block included in the request statement using the user account encryption/decryption key generated based on the authentication block, when the header value included in the request statement satisfies the preset specification.

5. The method of claim 3, further comprising:
registering, by the cloud pocket, a result of performing a function corresponding to the request statement into the table of the gate server after accessing the gate server at the preset interval; and
confirming, by the user terminal, the result of performing the function registered in the table of the gate server.

6. The method of claim 3, further comprising:
connecting, by the cloud pocket, to a main server among a plurality of main servers, and storing a result of performing a function corresponding to the request statement in a table within a database of the main server;
transmitting, by the main server, a vault ID corresponding to the table to the cloud pocket;
registering, by the main server, the result of performing the function in respective databases of remaining main servers among the plurality of main servers, excluding the main server, by interworking with each of the remaining main servers;
receiving, by the cloud pocket, the vault ID transmitted from the main server;
registering, by the cloud pocket, the vault ID in the table of the gate server after accessing the gate server at the preset interval; and
confirming, by the user terminal, the vault ID registered in the table of the gate server.
